(19) United States
(12) Patent Application Publication
(10) Pub. No.: US 2015/0324766 A1
(43) Pub. Date: Nov. 12, 2015

(54) PAYMENT BY PROXY SERVICE USING PAYMENT CARD

(71) Applicant: KT CORPORATION, Gyeonggi-do (KR)

(72) Inventors: Tae-Min PARK, Gyeonggi-do (KR); Byoung-Chan MIN, Seoul (KR); Hae-Gyu RHY, Seoul (KR)

(73) Assignee: KT CORPORATION, Gyeonggi-do (KR)

(21) Appl. No.: 14/707,837

(22) Filed: May 8, 2015

(30) Foreign Application Priority Data
May 8, 2014 (KR) 10-2014-0054852

(51) Int. Cl. G06Q 20/10

(52) U.S. Cl. CPC G06Q 20/10

(57) ABSTRACT

The disclosure is related a payment-by-proxy service that receives a payment request made by a joint payment card and processes the received payment request by a primary payment card linked to the joint payment card through a payment card processing system including, user devices, a payment terminal of a merchant, a service server of the payment-by-proxy service, and financial institution servers associated with the payment card and the primary payment card. For such a service, a payment card may be configured to store an identification data used for requesting a payment and an initiation data used for processing a payment through the payment-by-proxy service, to generate an initiation message based on the stored initiation data upon receipt of a request signal for the identification data from the payment terminal, and to transmit the generated initiation message to the payment card processing system in response to the request for the identification data.

### CROSS REFERENCE TO PRIOR APPLICATIONS

The present application claims priority under 35 U.S.C. §119 to Korean Patent Application No. 10-2014-0054852 (filed on May 8, 2014).

### BACKGROUND

The present disclosure relates to electronic commerce and, more particularly, to enabling one to make a payment for the others using one's a payment card.

Lately, consumers are able to make payments through various types of payment means including payment cards. The payment card is a card that might be used by a consumer and accepted by a merchant to make a payment for purchasing a good or a service. The payment card includes a credit card, a debit card, an automated teller machine (ATM), a charge card, a stored-value card, a gift card, and so forth.

A typical payment service issues a payment card to each cardholder through a complicated security and authorization procedure. Once the payment card is issued to one cardholder, such a payment card cannot be used by other person. When the cardholder wants to use own payment card for paying for a desired person, the cardholder has to be present at a point of sale with the desired person. Due to such limitation and inconvenience, it is very difficult to use one′ a payment card for making a payment for others.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present disclosure overcome the above disadvantages and other disadvantages not described above. Also, the embodiments of the present disclosure are not required to overcome the disadvantages described above, and embodiments of the present disclosure may not overcome any of the problems described above.

In accordance with an aspect of the present embodiment, a cardholder may be enabled to use own payment card for remotely making a payment for a desired person.

In accordance with another aspect of the present embodiment, a payment-by-proxy service may be provided to registered members through user devices of the registered members, a service server of a service provider, at least one financial institution server associated with a payment card, and a payment terminal of a merchant in order to process a payment request using a payment card of a designated member although the payment request was made using a payment card of the other member.

In accordance with still another aspect of the present embodiment, when a payment is requested using a joint payment card at a point-of-sales (POS) terminal, the payment may be processed using a primary payment card linked to the joint payment card.

In accordance with yet another aspect of the present embodiment, a payment card may include initiation data in a predetermined data field for indicating a payment-by-proxy service and for initiating operations of the payment-by-proxy service.

In accordance with yet another aspect of the present embodiment, single payment card may include information on a plurality of payment cards for requesting a payment using one payment card and processing the requested payment using the other payment card.

In accordance with yet another aspect of the present embodiment, one cardholder may be authenticated at a point of sale based on information on a first payment card issued to the one cardholder and may make a payment at the same point of sale based on information on a second payment card issued to another cardholder by single time presentation of the first payment card at the same point of sale.

In accordance with yet another aspect of the present embodiment, one time presentation of a first payment card at a point of sale may enable requesting a payment based on information on the first payment card and processing the requested payment based on information on a second payment card linked to the first payment card.

In accordance with at least one embodiment, a payment card may be provided for a payment-by-proxy service that receives a payment request made by the payment card and processes the payment request by a primary payment card linked to the payment card, through a payment card processing system including a payment terminal of a merchant, a service server of the payment-by-proxy service, and financial institution servers associated with the payment card and the primary payment card. Such a payment card may be configured to store an identification data used for requesting a payment and an initiation data used for processing a payment through the payment-by-proxy service, to generate an initiation message based on the stored initiation data upon receipt of a request signal for the identification data from the payment terminal, and to transmit the generated initiation message to the payment card processing system in response to the request for the identification data. The generated initiation message may invoke the payment card processing system to obtain information on the primary payment card linked to the payment card and to use the obtained information on the primary payment card for processing a payment request made at the payment terminal based on the identification data of the payment card.

The payment card may be configured to transmit the generated initiation message to the payment terminal when the payment card transmits a signal containing the identification data to the payment terminal in response to the request signal transmitted from the payment terminal. In this case, upon the receipt of the generated initiation message, the payment terminal generates a payment request message to include information on the payment request based on the identification data, transmits the payment request message to the service server, receives a message containing information on the primary payment card registered to be linked to the payment card from the service server, and process the payment request using the received information on the primary payment card instead of the identification information on the payment card.

The payment card may transmit the generated initiation message to the payment terminal when the payment card transmits a signal containing the identification data to the payment terminal in response to the request signal transmitted from the payment terminal. In this case, the payment terminal transmits a payment request message made based on the identification data of the payment card to the service server instead of a financial institution server of the payment card.

The payment card may include a plastic payment card including an integrated chip storing the initiation data and the identification data, a plastic payment card including a magnetic strip containing the initiation data and the identification data, a mobile payment card which is installed in, displayed on a user device, coupled to a predetermined memory sector for storing the initiation data generated by the service server, a digital form of the payment card generated by the service server to include the initiation data and transmitted to the user device, and a predetermined code pattern image generated by the service server to represent the initiation data and the identification data and transmitted to and displayed on the user device.

In accordance with another embodiment, an apparatus may be for providing a payment-by-proxy service that receives a payment request made by a joint payment card and processes the payment request by a primary payment card linked to the joint payment card through a payment card processing system including user devices associated with the joint payment card and the primary payment card, a payment terminal of a merchant, and financial institution servers associated with the joint payment card and the primary payment card. The apparatus may include a communication circuit configured to transmit data, signals, and messages to and to receive data, signals, and messages from at least one of the user devices, the payment terminal, and the associated financial institution servers, a memory configured to store information on a plurality of cardholders registered for the payment-by-proxy service, identification data of payment cards of each cardholder, and information on primary payment cards and joint payment cards of each cardholder, a processor configured to generate an initiation data for each registered cardholder upon registration of each cardholder, to identify a first joint payment card based on information included in a payment request message received from and generated by the payment terminal based on identification data of the first joint payment card, to determine a first primary payment card linked to the first joint payment card based on information stored in the memory and the information included in the payment request message, and to transmit information on the determined first primary payment card to the payment terminal. The payment terminal receives the identification data of the first primary payment card from the apparatus and uses the received identification data of the first primary payment card to process the payment request made using the first joint payment card.

The apparatus may receive a request message for a service application from a first user device and transmit the requested service application to the first user device. Upon receipt of the service application, the first user device is invoked to install and execute the service application for producing computing environments and user interfaces for interacting with at least one of the apparatus, the payment terminal, and the associated financial institution servers for the payment-by-proxy service.

The apparatus may request and receive registration information of each registered cardholder through the computing environments and the user interfaces, produced by executing the service application in an associated user device and displayed on a touch screen of the associated user device. The registration information includes information on at least one primary payment card, information on associated joint payment card, information on a primary cardholder, and information on associated joint cardholders.

The apparatus may request setting at least one of payment conditions and a selection policy of each registered cardholder and receive information on the setting result of the payment conditions and the selection policy through the computing environments and the user interfaces, produced by executing the service application in an associated user device and displayed on a touch screen of the associated user device, and store the received information on the payment conditions and the selection policy of each cardholder.

The apparatus may generate the initiation data based on information on the first joint payment card and to transmit the generated initiation data to the first user device associated with the first joint payment card. In this case, the first user device may be configured to receive the initiation data from the apparatus, to store the received initiation data in a memory, and to transmit the initiation data to the payment terminal when the payment terminal requests the identification data of the first joint payment card. The payment terminal may be configured to transmit a payment request message created based on the identification data of the first joint payment card to the apparatus when the payment terminal receives the initiation data from the first user device in response to the request for the identification of the first joint payment card, to receive the identification data of the first primary payment card from the apparatus in response to the payment request message, and to use the identification data of the first primary payment card for processing the payment request made at the payment terminal using the identification data of the first joint primary payment card.

The apparatus may generate the initiation data based on information on the first joint payment card and to transmit the generated initiation data to the first user device associated with the first joint payment card. In this case, the first user device is configured to receive the initiation data from the apparatus, to configure a mobile payment card of the first joint payment card to include the received initiation data, and to display the mobile payment card on a screen of the first user device in order to transmit the initiation data to the payment terminal when the payment terminal requests the identification data of the first joint payment card. The payment terminal is configured to indicate the initiation data in the mobile payment card, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

The apparatus may generate a dummy mobile payment card including the initiation data based on information on the first joint payment card and to transmit the generated dummy mobile payment card to the first user device associated with the first joint payment card. In this case, the first user device is configured to receive the dummy mobile payment card from the apparatus and to display the dummy mobile payment card on a screen of the first user device in order to transmit the initiation data to the payment terminal when the payment terminal requests the identification data of the first joint payment card. The payment terminal is configured to indicate the initiation data in the dummy mobile payment card, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

The apparatus may generate a code pattern image including the initiation data based on information on the first joint payment card and to transmit the generated code pattern image to the first user device associated with the first joint payment card. In this case, the first user device is configured to receive the code pattern image from the apparatus and to display the code pattern image on a screen of the first user device in order to transmit the initiation data to the payment terminal when the payment terminal requests the identification data of the first joint payment card. The payment terminal is configured to indicate the initiation data in the code pattern image, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

The apparatus may transmit the identification data of the first primary payment card to the payment terminal when payment conditions of the first primary payment card are satisfied based on information on the payment request made through the first joint payment card.

The apparatus may transmit an approval request message to a second user device associated with the first primary payment card when receiving the payment request message made using the first joint payment card of the first user device and transmit the identification data of the first primary payment card to the payment terminal when receiving an approval message from the second user device.

The apparatus may select one obtaining most benefits of use from multiple primary payment cards when multiple primary payment cards are linked to the first joint payment card used to make the payment request message from the payment terminal and transmit identification data of the selected primary payment card to the payment terminal.

In accordance with still another embodiment, a payment terminal may be provided for a payment-by-proxy service that receives a payment request made by a joint payment card and processes the payment request by a primary payment card linked to the joint payment card through a payment card processing system including user devices associated with the joint payment card and the primary payment card, a service server for the payment-by-proxy service, and financial institution servers associated with the joint payment card and the primary payment card. The payment terminal may be configured to receive a payment request message with identification data of a first joint payment card, to detect an initiation data in the payment request message, and to transmit the payment request message to the service server instead of a financial institution server associated with the identification data of the first joint payment card.

The payment terminal may receive an identification data of a first primary payment card linked to the first joint payment card from the service server and use the received identification data of the first primary payment card to process the payment request made by the identification data of the first joint payment card.

The payment terminal may receive an identification data of a first primary payment card linked to the first joint payment card from the service server and transmit the payment request made by the first joint payment card to a financial institution server associated with the first primary payment card.

The payment terminal may receive an initiation data with an identification data of a payment card when a payment request is made using the identification data of the payment card and initiate a payment-by-proxy service operation upon the receipt of the initiation data.

The payment terminal may transmit a payment request made based on a first joint payment card to the service server upon detection of an initiation data, and he payment terminal may receive a result of processing the payment request based on a first primary payment card linked to the first joint payment card from a financial institution server associated with the first primary payment without receiving the identification data of the first primary payment from the service server and without transmitting the payment request to the financial institution server associated with the first primary payment card.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates a payment card processing system in accordance with at least one embodiment;

FIG. 2 illustrates a service server and a point-of-sale (POS) terminal for providing a payment-by-proxy service in accordance with at least one embodiment;

FIG. 3 illustrates overall operation of a payment card processing system for a payment-by-proxy service in accordance with at least one embodiment;

FIG. 4 is a flowchart illustrating operation of a service server for a payment-by-proxy service in accordance with at least one embodiment;

FIG. 5 illustrates payment cards classified into a primary payment card and a joint payment card in accordance with at least one embodiment;

FIG. 6 illustrates graphic user interfaces displayed on a user device for registration and entering registration information in accordance with at least one embodiment;

FIG. 7 illustrates graphic user interfaces displayed on a user device for setting payment conditions for each joint cardholder in accordance with at least one embodiment;

FIG. 8 illustrates graphic user interfaces displayed on a user device for setting a selection policy for selecting one from multiple primary payment cards in accordance with at least one embodiment;

FIG. 9 illustrates operation of a service server for a payment-by-proxy service in accordance with an embodiment; and

FIG. 10 illustrates operation of a service server for a payment-by-proxy service in accordance with another embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

In accordance with at least one embodiment, a cardholder registered for a payment-by-proxy service may be enabled to make a payment for a desired person at a remote location by using a designated payment card without complicated registration and authorization procedures, without modifying a typical process for processing a payment through a payment card, and without physically presenting with the desired person at a location of a point of sale. In order for enabling such a payment-by-proxy service, a registered cardholder may be enabled to virtually link at least one primary payment card of the registered cardholder with a plurality of joint payment cards of desired persons. When a payment is requested using one of the joint payment cards, such a payment is processed and made based on the primary payment card virtually linked with the joint payment cards. Such a payment-by-proxy service allows one cardholder to securely and legally allow the others at a remote location to use one's payment card without physically handing over the payment card. In addition, one cardholder may be enabled to conveniently and automatically obtain maximum benefits of using one selected payment card by virtually linking the selected payment card to a plurality of joint payment cards and by allowing joint cardholders of the joint payment cards to use the selected payment card through the payment-by-proxy service in accordance with at least one embodiment.

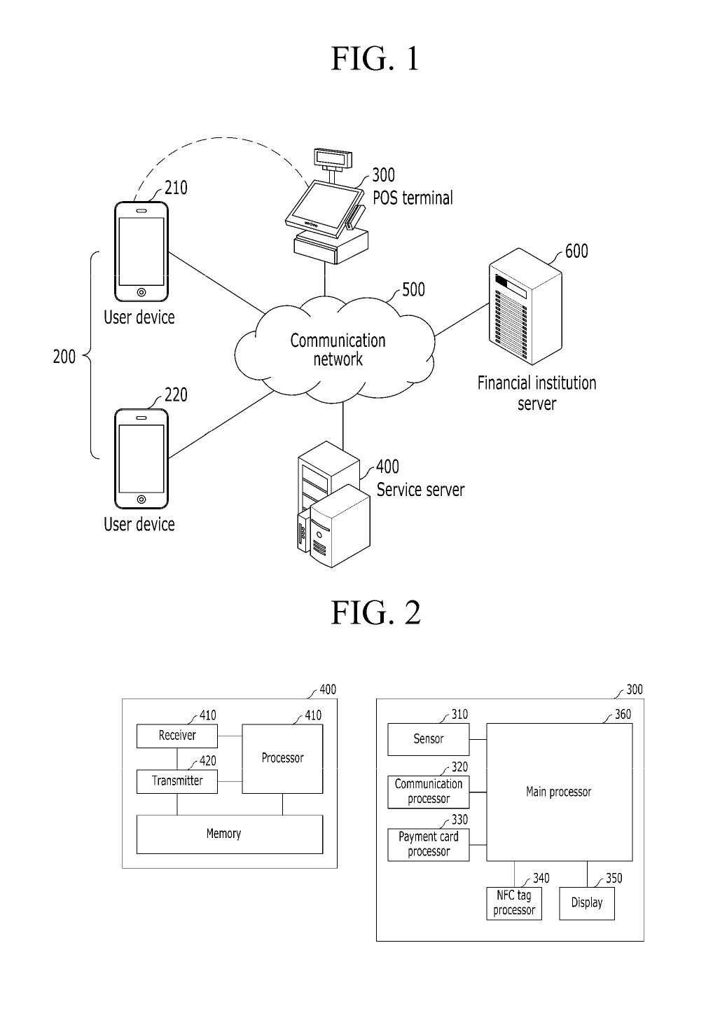

Such a payment-by-proxy service is implemented through a service server with a typical system for electronic commerce or processing payment cards. Hereinafter, the payment-by-proxy service in accordance with at least one embodiment will be described based on the typical payment card processing system with reference to FIG. 1.

FIG. 1 illustrates a payment card processing system in accordance with at least one embodiment. Referring to FIG. 1, payment card processing system 100 may denote a set of entities for enabling one cardholder to pay a payment made by the other by using one's payment card at a remote place from the other. In particular, payment card processing system 100 may perform operations for enabling one cardholder i) to register for a payment-by-proxy service and upload information on at least one primary payment card and at least one joint payment card, ii) virtually link at least one primary payment card with a plurality of joint payment cards and ii) process a payment based on the primary payment card upon the reception of a payment request made based on one of the joint payment cards. For example, such payment card processing system 100 may include user device 200 (e.g., first and second user devices 210 and 220), Point-of-Sale (POS) terminal 300, service server 400, and communication network 500, but the present embodiment is not limited thereto. User devices 210 and 220, POS terminal 300, and service server 400 may be coupled through communication network 500. At least one of user devices 210 and 220 may be coupled to POS terminal 300 through a wireless communication link. POS terminal 300 and service server 400 may be coupled to each other through various types of communication networks, for example, communication network 500.

Although it is not shown in FIG. 1, other entities may be included in payment card processing system 100 in order to process a payment request made in association with at least one of user device 210, user device 220, POS terminal 300, and service server 400. Such entities may include computing devices related to electronic commerce such as mobile commerce, electronic funds transfer, internet marketing, online transaction processing, electric data interchange, inventory management system, automated data collections system, and so forth. For example, payment card processing system 100 may further include at least one of financial institution servers (e.g., financial institution server 600) each associated with a respective payment card. Such financial institution servers may include a value added network (VAN) server and a payment gateway.

In payment processing system 100, a payment may be requested based on one of joint payment cards, and such requested payment may be processed based on a primary payment card virtually linked with the joint payment cards in accordance with at least one embodiment. Such a service may be referred to as a payment-by-proxy service. Through the payment-by-proxy service, a user may be securely make a payment for another (e.g., child, spouse, and any desired person) at a remote place without complicated security and authorization procedures and without modifying a typical payment processing system for various types of existing payment cards, such as a credit card.

In order to have such a service, i) a user (e.g., a cardholder, a service member) may register for the payment-by-proxy service at service server 400, ii) the user may download a related software program (e.g., application or app) from service server 400 and install the downloaded software program at designated device such as user device 200, and iii) a user may store information on payment cards in at least one of service server 400 and user device 200. The payment-by-proxy service may be operated based on financial agreement and regulation among financial institutions and service providers, and performed from or via user device 200. Such a payment-by-proxy service may be implemented with a mobile payment service, but the embodiments of the present disclosure are not limited thereto. The mobile payment service is a service for making a payment through a mobile payment card, also operated under financial agreement and regulation, and performed from or via user device 200. Instead of paying with cash, cheque, or credit cards, a consumer can use user device 200 installed with the mobile payment card to pay for a wide range of services and digital or hard goods.

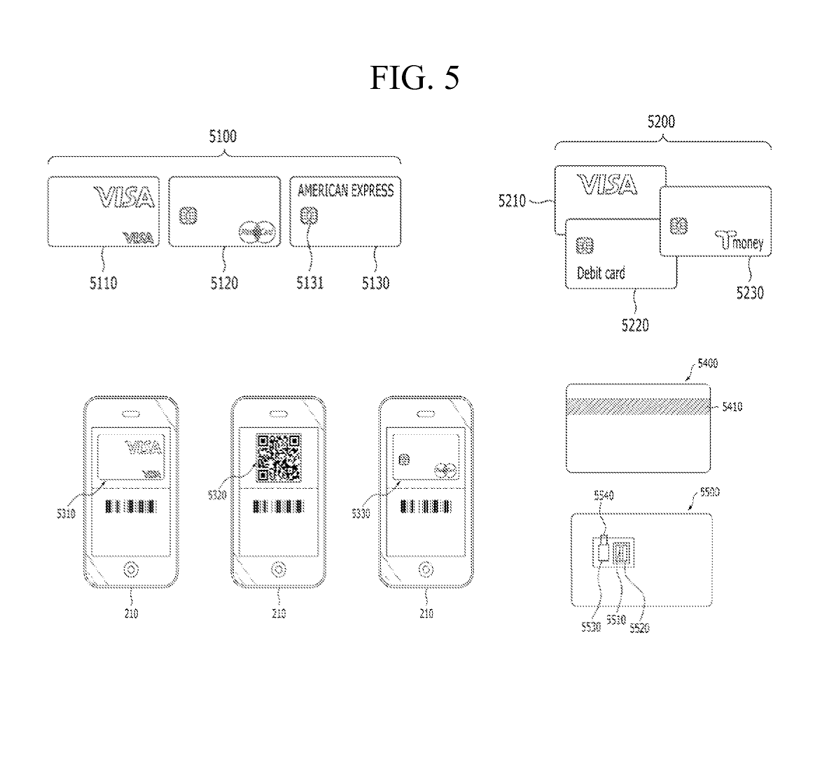

In accordance with at least one embodiment, the payment card may be a card that can be used by a cardholder and accepted by a merchant to make a payment for a purchase or in payment of some other obligation. For example, FIG. 5 illustrates various types of payment cards, which may be designated as a primary payment card and a joint payment card by a registered member in accordance with at least one embodiment.

Referring to FIG. 5, a payment card in accordance with at least one embodiment may be a typical plastic payment card made (e.g., 5110, 5210, 5400) of plastic material and including a magnetic strip, and a smart card (e.g., 5120, 5220, 5230, 5500) made of plastic material and including not only magnetic strip but also an integrated circuit (IC) chips for near field communication (NFD) and a radio frequency identification (RFID) chip. Such typical and smart payment cards may be scanned by POS terminal 300 or establish a wireless communication link to POS terminal 300 for providing information on the payment card, such as payment card identification and cardholder identification, which are referred to as identification data. Such payment card includes credit cards 5110 to 5130 and 5210, debit card 5220, an automated teller machine (ATM) card, a charge card, stored-value card 5230, a gift card, a membership card, and so forth.

Payment card 5400 of FIG. 5 denotes one type of payment cards for the payment-by-proxy service in accordance with at least one embodiment. Particular, payment card 5400 may include magnetic strip 5410 for storing an identification data and an initiation data. As described, the identification data denotes information of a payment card for making a payment request at a terminal of a merchant (e.g., POS terminal 300) and processing a payment in cooperation with associated financial institution servers. The initiation data denotes information for indicating that an associated cardholder (e.g., owner of the payment card) is registered for the payment-by-proxy service and for initiating predetermined operations for the payment-by-proxy service in accordance with at least one embodiment. Such initiation data may be stored in magnetic strip 5410 and be read by POS terminal 300 when payment card 5400 is used to make a payment request at POS terminal 300 in accordance with at least one embodiment. In this case, POS terminal 300 may detect the initiation data before processing a requested payment. Upon the detection, POS terminal 300 delivers the identification data of payment card 5400 to service server 400 and waits for a control message (e.g., response message, information on a primary payment card, or denial message) instead of initiating process of the requested payment by transmitting the payment request message to financial institution server 600 associated with payment card 5400.

As another example, the payment card may include a smart card capable of processing predetermined instructions and storing data. As shown in FIG. 5, payment cards 5120, 5130, 5220, and 5230 may be a contactless, multifunctional, and programmable smart card employing a near field communication (NFC) and/or a radio frequency identification (RFI) technology. As an example, payment card 5500 may be capable of storing not only an identification data of payment card 5500 but also an initiation data for the payment-by-proxy service and at least one executable data, and capable of processing the stored data in response to predetermined event and performing operations as the result of the processing. For example, the executable data may be a set of instructions, such as an applet. Payment card 5500 may be capable of receiving data from and having circuits programmable by a user device (e.g., user device 200) equipped with short-distance communication circuits (e.g., NFC or RFID). Payment card 5500 may be capable of establish a wireless communication link to a designated device (e.g., POS terminal 300) and transmitting an identification data and an initiation data to the designated device upon generation of predetermined events.

In accordance with at least one embodiment, payment card 5200 may receive the initiation data from user device 200 through a short distance communication link established between payment card 5200 and user device 200 when user device 200 receives the initiation data from service server 400, which is created as a result of registering payment card 5200 as a joint payment card. Furthermore, payment card 5200 may be programmed by user device 200 to transmit the initiation data to POS terminal 300 with the identification data. For example, a service application, provided from service server 400 for the payment-by-proxy service, and installed and executed in user device 200, may produce and display a graphic user interface for guiding installing and storing at least one of a service applet and the initiation data when user device 200 receives the initiation data with the service applet from service server 400. The initiation data may be created to include the service applet, but the present embodiment is not limited to. In particular, when user device 200 receives the initiation data from service server 400, it may invoke user device 200 to display a graphic user interface requiring making a touch input with payment card 5200. Upon the make of the touch input with payment card 5200, a short-distance communication link may be established between payment card 5200 and user device 200, the initiation data may be transferred from user device 200 to payment card 5200 through the short-distance communication link, and the initiation data may be stored in payment card 5200 in predetermined sections of a memory in payment card 5200.

When POS terminal 300 requests the identification data of payment card 5200 for processing a payment, payment card 5500 may provide the identification data stored in the predetermined sector of the memory to POS terminal 300. Or, upon the request of the identification data from POS terminal 300, the service applet stored in payment card 5200 may be initiated, the stored initiation data may be fetched from a predetermined memory section, and the fetched initiation data may be transmitted to POS terminal 300.

Referring to FIG. 5, such payment card 5500, a multifunctional, programmable, and contactless smart card, may include control processor 5510, memory 5520, radio frequency (RF) interface processor 5530, and RF antenna 5540. Such constituent elements of payment card 5500 may be designed to interact with each other based on related International standards or a common chip set design. For example, payment card 5500 may employ a Mifare chip structure and Global Platform standards. Each of constituent elements may be designed to have a structure and to interact with each other based on the Mifare chip structure and Global Platform standards.

Memory 5520 may store necessary information to be recognized as a payment card, such as an identification data, and information for the payment-by-proxy service, such as the initiation data and service applets. Memory 5520 may have a specific memory format and store the information at predetermined memory sectors which are decided and appointed by a related international standard organization and a related service provider group. For example, memory 120 has a Mifare Classic memory structure. That is, predetermined memory sectors of the Mifare Classic memory structure may be defined to store the initiation data and the service applets for the payment-by-proxy service.

Control processor 5510 may perform general operations for performing a typical payment processing service and the payment-by-proxy service. For example, control processor 5510 may perform operations for fetching and transmitting the initiation data and for executing the service applets. RF interface processor 5530 may transmit and receive data with user device 200 and POS terminal 300 through RF antenna 5540.

In addition, the payment card in accordance with at least one embodiment may include a mobile payment card. For example, the payment card may include a mobile payment card, for example, mobile payment card 5310 displayed on user device 210 of a primary cardholder, as shown in FIG. 5. The mobile payment card may be a digital version of a typical plastic payment card. The mobile payment card may be referred to as a digital payment card, mobile money, mobile money transfer, and mobile wallet. Such a mobile payment card may be downloaded from an associated financial institution server and installed in a designated device (e.g., user device 200) by an associated user. With such mobile payment card, a mobile payment service may be provided to an associated user. In the case of the mobile payment card, the initiation data may be generated by service server 400, transmitted to user device 200, and stored in a predetermined memory section in a memory of user device 200. User device 200 may modify the existing mobile payment card (e.g., an image of a mobile payment card) to include the initiation data and/or transmit the initiation data to POS terminal 300 upon generation of a predetermined event.

In accordance with at least one embodiment, a payment card may be designated as primary payment cards 5100 and joint payment cards 5200. For example, a cardholder may select one from a plurality of first type payment cards and designate the selected payment card as a primary payment card for the payment-by-proxy service. Herein, the first type payment cards are payment cards legally belonging to and issued to a cardholder by internationally authorized agency. That is, the first type payment cards are legally issued to a user by an associated financial institution (e.g., banks or credit card companies) and/or registered with the user as a legal cardholder. A cardholder selects one from the first payment cards and registered at service server 400 for the payment-by-proxy service. The cardholder designates the selected payment card for making a payment made by another (e.g., authorized persons). Such a cardholder of the selected payment card may be referred to as a primary cardholder, and the selected payment card may be referred to as a primary payment card. The first type payment card may be a credit card, such a VISA credit card, a Master credit card, an AMEX credit card, and a Discover credit card. It is not required to select a primary payment card from credit cards. Since the credit cards are issued to a cardholder through a serious security and authorization process and processed a stable and secure system, a payment-by-proxy service might be provided more securely than using other types of payment cards issued by third parties (e.g., merchants or private organization). Such selection and designation may be performed through user device 200 of the cardholder in connection with service server 400.

For example, a cardholder may select at least one from second type payment cards and designate the selected payment card as a joint payment card. The second type payment cards may include not only payment cards belonging to the cardholder but also payment cards belonging to other persons (e.g., family member, friends, colleagues, and so forth). In case of the payment cards belong to other persons, the cardholder may be required to have permission from a cardholder of a second type payment card with information thereof through user device 200, service server 400, and/or server associated with the second type payment card. The second type payment cards may be not only a credit card but also other types of payment cards including a transportation card, a membership card, and so forth. The second type payment cards could be a payment card that has information to be used to authenticate an associated cardholder because the second type payment cards may be used to authenticate a cardholder at a point of sale although it might not be used to process a payment at the same point of sale. Such selection and designation may be performed through user device 200 and service server 400. A payment card linked to a primary payment card may be referred to as a joint payment card, and a cardholder having the joint payment card may be referred to as a joint cardholder. That is, a primary cardholder pays for associated joint cardholders using at least one of payment cards belonging to the primary cardholder through the payment-by-proxy service in accordance with at least one embodiment.

In accordance with at least one embodiment, a cardholder registered for the payment-by-proxy service may virtually link a primary payment card with at least one joint payment card through user equipment 200 and service server 400. For example, a registered cardholder registers a primary payment card and associated joint payment cards in service server 400 through user device 200 during a service registration procedure. Such linking and registration may be performed through user device 200 and service server 400.

As described, the payment card may be a mobile payment card and a typical plastic payment card. After the payment card is designated as a joint payment card and linked with a primary payment card, such a payment card may include data that initiates a terminal of a merchant (e.g., POS terminal 300) to perform predetermined operation for the payment-by-proxy service. For example, service server 400 may generate such data (e.g., initiation data) upon registration of a primary payment card and associated joint payment cards and transmit the generated data to a user device of the joint payment card or an associated financial institution server of the joint payment card. The initiation data may further include a set of executable files for initiating a designated device to perform operations for the payment-by-proxy service and information on service server 400.

Upon the receipt of the initiation data, the user device may include the received initiation data in a mobile joint payment card (e.g., a digital version of the joint payment card) to be transmitted to a payment terminal (e.g., POS terminal 300) whenever the mobile joint payment card is used to make a payment at the payment terminal. For example, FIG. 5 shows mobile joint payment cards 5310 and 5330 modified to include the received initiation data after the mobile payment cards are registered as a joint payment card. Such initiation data may include information on identification of an associated primary cardholder, identification of an associated primary payment card, and so forth.

The present embodiment, however, is not limited thereto. For example, without modifying a mobile payment card of the joint payment card to include the received initiation data, the user device may store the received initiation data in a predetermined memory sector and transmit the received initiation data to a payment terminal (e.g., POS terminal 300) of a merchant separately from payment card information (e.g., identification data of mobile payment card) whenever the associated mobile payment card is used at the payment terminal.

In addition, a user device may transmit the received initiation data to an integrated circuit (IC) chip of a payment card designated as a joint payment card through near field communication (NFC) technology, short distance communication technology, or radio frequency identification (RFID) technology. For example, FIG. 5 shows Jason's payment card 5220 including an IC chip. Referring to FIG. 5, after Jason's payment card 5220 is designated and registered as a joint payment card, Jason's user device 210 may receive the initiation data from service server 400, transmit the received initiation data to Jason's payment card 5220, and store the initiation data in the IC chip. When Jason uses payment card 5220 at a payment terminal, the initiation data may be transmitted with typical information stored in payment card 5220 to the payment terminal or the payment terminal reads the initiation data with the typical information stored in payment card 5220.

In accordance with another embodiment, service server 400 may transmit initiation data to an associated financial institution server. In this case, the financial institution server may reissue a typical plastic payment card with the received initiation data included therein and deliver the reissued payment card to a joint cardholder. In this case, a magnetic strip and/or an IC chip of a reissued payment card include the initiation data for the payment-by-proxy service. A payment terminal may read or scan typical information on a payment card with the initiation data from the payment card when the payment card is presented at the payment terminal.

However, the present embodiment is not limited thereto. When financial institution server 600 receives the initiation data from service server 400, financial institution server 600 may store the received initiation data in connection with identification information on an associated cardholder and/or associated payment card in a database of financial institution server 600 without reissuing the associated payment card to the associated cardholder. For example, when financial institution server 600 receives a payment request from POS terminal 300, financial institution server 600 determines whether the received payment request is made based on payment cards registered for the payment-by-proxy service based on information stored in the database. When the received payment request is made based on the payment card (e.g., a joint payment card) registered for the payment-by-proxy service, financial institution server 600 i) may process the payment request based on information on a primary payment card linked to the joint payment card and provide a result of processing to POS terminal 300, ii) may deliver the received payment request to another financial institution server associated with the primary payment card and transmit an informing message to POS terminal 300, and iii) transmit an informing message to POS terminal 300 with information on the primary payment card and request POS terminal 300 to process the payment request based on the information on the primary payment card.

In addition, service server 400 may generate a virtual dummy card or a predetermined code pattern image to include such initiation data and transmit the generated virtual dummy card (e.g., mobile joint payment card 5330) or code pattern images (e.g., QR code 5320) to a user device of a joint cardholder, as shown in FIG. 5. Such virtual dummy card 5330 and code pattern image 5320 may include information on a joint payment card, an associated primary payment card, and the initiation data that initiates operations for the payment-by-proxy service in accordance with at least one embodiment. Furthermore, virtual dummy card 5330 and code pattern image 5320 may include a set of executable files (e.g., applet) and information on service server 400. Such initiation data may be referred to as a payment type field containing a predetermined value and included in a typical data structure of credit card information stored in at least one of a magnetic strip and an IC chip of a typical plastic card, mobile payment cards, a designated memory sector of an associated user device, and so forth. For example, when a value of the payment type field is “1”, a payment request is processed through the payment-by-proxy service. When a value of the payment type field is “0” or Null or when the payment type field is not included, a payment request may be processed through a typical payment card process.

In accordance with at least one embodiment, two types of information (e.g., an identification data and an initiation data) may be stored in a payment card for the payment-by-proxy service. The identification data may denote payment card information for typical payment card processing, and the initiation data may denote any necessary data for performing the payment-by-proxy service. For example, the initiation data may include initiation-bits (e.g., payment type data field) for indicating and initiating the payment-by-proxy service, information on service server 400 (e.g., internet address) for transmitting a payment request to service server 400, and a set of executable files (e.g., applets) for controlling a designated device (e.g., POS terminal 300, user device 200) to perform predetermined operations. Furthermore, the initiation data may include information on an associated primary cardholder, associated payment conditions, and a selection policy.

Referring back to FIG. 1, after registration, when POS terminal 300 requests a payment made based on a joint payment card, such requested payment is processed based on a primary payment card virtually linked with the joint payment card. That is, although a joint payment card is used to make a payment request at POS terminal 300, a primary payment card linked to the joint payment card is used to process the payment. For example, POS terminal 300 may transmit all of payment requests to service server 400 with information on a payment card used to make the payment request whenever the payment request is made at POS terminal 300. Alternatively, POS terminal 300 transmits such a payment request when POS terminal 300 detects the initiation data in a payment card used for the payment request. Otherwise, POS terminal 300 may transmit the payment request to a financial institution of the payment card used for making the payment request.

Referring to FIG. 5, in the case of a family having four family members: John (father), Kelly (mother), Jason (son), and Joshua (son), John may i) select one of payment cards 5100 issued to John and designate the selected one as a primary payment card, ii) select one 5210 of payment cards issued to Kelly and designated the selected one as a first joint payment card, iii) select one 5220 of payment cards issued to Jason and designated the selected one as a second joint payment card, iv) select one 5230 of payment cards issued to Joshua and designated as a third joint payment card, v) virtually link the primary payment card of John with the first to third joint payment cards of Kelly, Jason, and Joshua by registering the primary payment card with the first to third joint payment cards at service server 400 with information on the primary payment card and the first to third joint payment cards. After registration, Kelly, Jason, and Joshua may respectively have mobile joint payment card 5310, QR code 5320, and dummy mobile card 5330, as digital version of joint payment cards, as shown in FIG. 5.

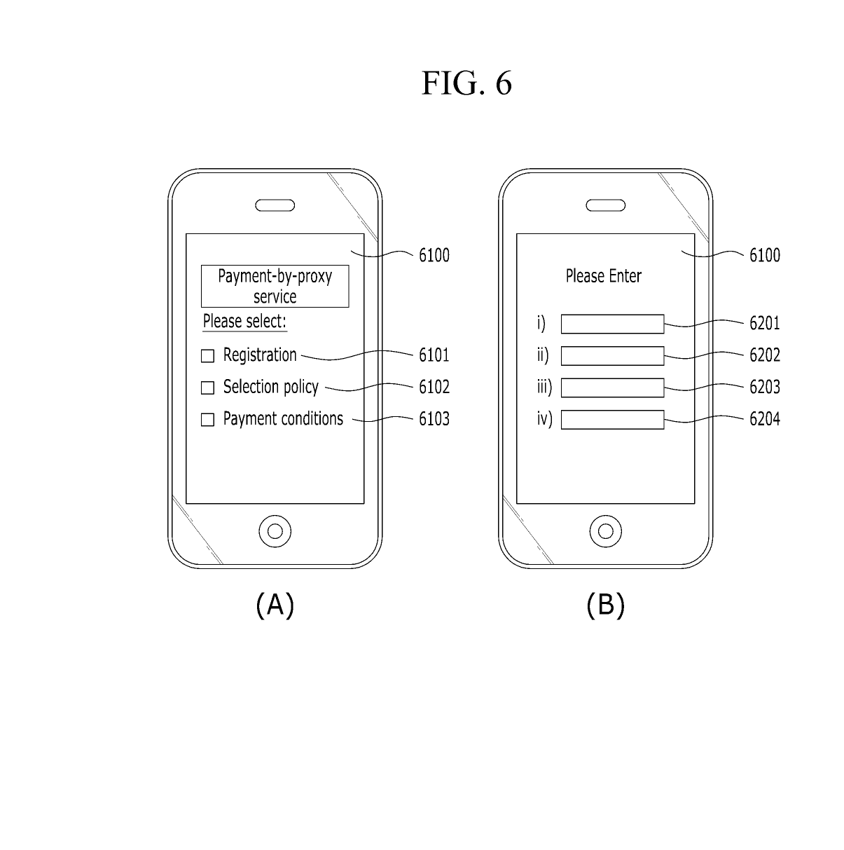

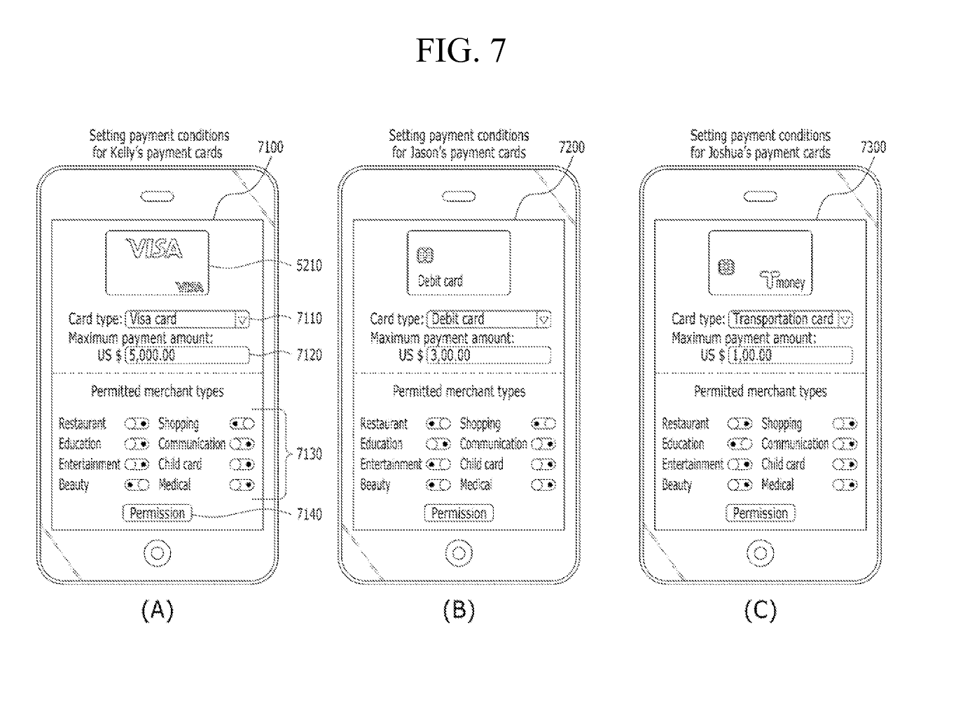

When any of family members, Kelly, Jason, and Joshua, uses the first to third joint payment cards 5310, 5320, and 5330 to pay any purchases at POS terminal 300, such payments are processed using John's payment card which is designated as primary payment card 5110 linked to first to third joint payment cards 5310, 5320, and 5330 of Kelly, Jason, and Joshua. In addition, John may be enabled to set payment conditions for Kelly, Jason, and Joshua through service server 400 and user device 200. For example, FIG. 6 and FIG. 7 show graphic user interfaces for enabling a cardholder to setting payment conditions. Detailed description of such operation will follow with reference to FIG. 6 and FIG. 7. Accordingly, John could control spending of the family members using John's payment card while allowing the family members to use John's payment card without complicated authorizing and security procedure in accordance with at least one embodiment.

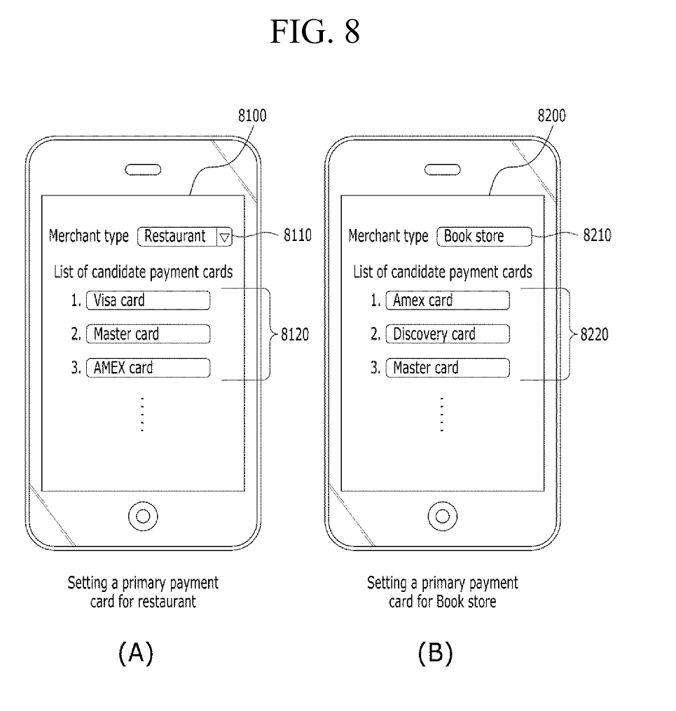

The embodiments of the present disclosure are not limited to linking one primary payment card to multiple joint payment cards as described above. For example, one joint payment card may be linked to multiple primary payment cards. In this case, when a payment is made through a joint payment card, one of associated primary payment cards may be selected based on various conditions (e.g., a selection policy). For example, one obtaining maximum benefits of use may be selected from the primary payment cards based on bonus benefits and benefit requirements of each primary payment card and benefits offered by an associated merchant. For example, FIG. 8 shows graphic user interfaces for setting a selection policy of each payment card for selecting one from multiple primary payment cards. Detailed description of such operation will follow.

As described, such a payment-by-proxy service may be performed through user device 200 and service server 400 in accordance with at least one embodiment. Such user device 200 may be coupled not only to service server 400 but also to various types of entities through communication network 500. That is, user device 200 (e.g., including user devices 210 and 220) is an electronic device that enables a user (e.g., cardholder registered for the payment-by-proxy service) to use a payment-by-proxy service in connection with POS terminal 300 and service server 400 in accordance with at least one embodiment. Such user device 200 may be electronic device having processing power, a memory, and communication capability. For example, user device 200 may include user equipment (UE), a personal computer (PC), a smartphone, a laptop computer, a personal digital assistance (PDA), and a portable multimedia player (PMP). The embodiments of the present disclosure, however, are not limited thereto.

In order to enable the payment-by-proxy service, user device 200 may download a dedicated software program, such as application or app from service server 400 and installs the downloaded software program. Hereinafter, such a dedicated software program may be referred to as a service application for convenience and ease of understanding. User device 200 may execute the service application installed therein in response to a user input. Such execution of the dedicated service application may produce a computing environment and a user interface for the payment-by-proxy service. That is, a computer environment may be created i) for establishing at least one of connections (e.g., session) between service server 400 and user device 200, between user device 200 and POS terminal 300, between user device 200 of a cardholder and a user device of the authorized person, and between user device 200 and an associated financial institution server, ii) for exchanging necessary data and messages through the established connections, and iii) for creating and displaying at least one user interface for enabling a cardholder to pay a desired payment for an authorized person. In addition, a computer environment may be created iv) for designating a predetermined section of a memory and storing initiation data, v) for transmitting the stored initiation data to a designated destination upon generation of a predetermined event, vi) for modifying a mobile payment card, stored and installed in the user device, to include the initiation data, vii) for receiving a predetermined code pattern image including the initiation data, storing the code pattern image at a predetermined memory section, and displaying the code pattern image on a screen thereof for making a payment request with the initiation data at POS terminal 300, and so forth. The user interface may be created to enable a user 1) for interacting with service server 400, 2) for interacting with associated financial institution servers, 3) for interacting with a user device of a joint cardholder, 4) for registering as a member for the payment-by-proxy service, 5) for registering information on at least one of payment cards, 6) for setting and registering payment-by-proxy policies (e.g., payment conditions) of each payment card, 7) for exchanging messages (e.g., approval messages) with service server 400, associated financial institution servers, and user devices of joint cardholders, 8) for making a payment of a predetermined purchase, 9) for displaying at least one of a mobile payment card, a dummy payment card, and a predetermined code pattern image, 10) for transmitting an initiation data to a designated device, 11) for receiving an initiation data from a service server, and so forth. However, the embodiments of the preset disclosure are not limited thereto.

Such a user interface may be a set of hardware buttons, knots, and keys of a user device, which are adequately modified, configured, and set for the payment-by-proxy service in connection with services server 400. In addition, the user interface may be a set of graphical buttons, icons, a list of menus, knots, and keys, which are displayed on a touch screen of a user device. In particular, the user interface may be a graphic user interface (GUI) that is displayed on a touch screen of a user device and includes various types of graphical buttons, icons, and knots for selecting, activating, setting, modifying, and controlling various operations, options, and conditions for the payment-by-proxy service. Examples of such a user interface are shown in FIG. 6 to FIG. 8. The detailed descriptions of the computing environment and the user interface for the payment-by-proxy service will follow with reference to FIG. 6 to FIG. 8.

Referring back to FIG. 1, POS terminal 300 may obtain information on a payment card from at least one of the payment card and user device 200 to process a payment for a purchase made by a cardholder. When a payment card is a typical plastic card having at least one of a magnet strip and an IC chip containing card information, a predetermined circuit part (e.g., a card reader or a short-distance communication interface) of POS terminal 300 reads such information from the magnet strip and/or the IC chip. When a payment card is a mobile payment card displayed on a screen of user device 200, a predetermined circuit part (e.g., a scanner or a code detector) of POS terminal 300 reads necessary information from the mobile payment card displayed on the screen of user device 200.

Furthermore, user device 200 may be coupled to POS terminal 300 of a merchant through a wireless link upon the generation of a predetermined event, such as entering a predetermined radius from POS terminal 300, touching a predetermined sensor of POS terminal 300, scanning a predetermined image displayed on user device 200, and so forth. Through such a communication link, user device 200 may transmit necessary information to POS terminal 300 for processing a payment not only through the payment-by-proxy service but also through a typical payment card processing service.

As described, POS terminal 300 is a payment terminal of a merchant at point of sale where a cardholder makes a payment to the merchant in exchange for goods or services. In accordance with at least one embodiment, POS terminal 300 receives a payment request with payment card information including initiation data for initiating the payment-by-proxy service from at least one of a payment card and user device 200. When POS terminal 300 detects the initiation data for the payment-by-proxy service, POS terminal 300 generates and transmits a payment request message to service server 400 for initiating the payment-by-proxy service in accordance with at least one embodiment. However, the embodiments of the present disclosure are not limited thereto. For example, POS terminal 300 may transmit all of payment requests to service server 400 whenever a payment request is made at POS terminal 300 and perform operations in response to messages from service server 400. Or, POS terminal 300 may transmit all of payment requests to a financial institution server associated with a payment card used to make the payment requests whenever a payment request is made at POS terminal 300 and perform operations in response to messages from the financial institution server. Such operation of POS terminal 300 may be similar to a typical process of processing a payment based on a typical payment card. In this case, the financial institution server may detect such initiation data included in the payment request and perform operations for the payment-by-proxy service in connection with service serer 400. For example, the financial institution server may perform similar operations performed by POS terminal 300 for the payment-by-proxy service.

After receiving information on a primary payment card associated with a joint payment card used to make a payment request, POS terminal 300 may perform operations for making a payment using the information on the primary payment card instead of information the joint payment card. Such operation may be similar to a typical operation for processing a payment using information on a typical payment card. For example, POS terminal 300 delivers the payment request with the information on the primary payment card to an associated financial institution server, such as a value added network (VAN) server.

Such financial institution server 600 may denote a service server acting as an intermediary for providing a payment processing service between user device 200 and service server 400 through POS terminal 300. Financial institution server 600 may be a VAN server or a payment gateway. In general, financial institution server 600 receives information on a payment card of a consumer from POS terminal 300 of a merchant through communication network, processes the payment request based on the information on the payment card, and transmits the request of the processing to at least one of POS terminal 300. In at least one embodiment, financial institution server 600 may transmit a payment request with the received payment card information to service server 400 for the payment-by-proxy service, receive a payment approval message from service server 400 with information on the primary payment card, process the payment request with the information on the primary payment card, and transmit the result of the processing to POS terminal 300.

In another embodiment, financial institution server 600 may receive initiation data from service server 400 when an associated payment card is registered for the payment-by-proxy service. Such initiation data may include information on at least one of an associated primary cardholder, an associated primary payment card, and payment conditions, as well as an initiation bit for indicating and initiation the payment-by-proxy service. Financial institution server 600 may create a database for storing such initiation data in connection with an associated payment card or an associated cardholder. In this case, financial institution server 600 may i) determine whether a received payment request is associated with the payment-by-proxy service based on information in the received payment request and the database upon the receipt of the payment request from POS terminal 300 and ii) obtain information on an associated primary payment card when the received payment request is associated with the payment-by-proxy service. Financial institution server 600 may: iii) process the payment request based on the obtained information on the associated primary payment card and provide the result of processing; iv) deliver the payment request to another financial institution server associated with the primary payment card and provide an informing message to POS terminal 300; or v) return the payment request to POS terminal with the information on the associated primary payment card and an informing message.

Referring to FIG. 1, service server 400 may be coupled to POS terminal 300 and user device 200 through communication network 500 and perform operations for the payment-by-proxy service in connection with user device 200 and POS terminal 300 in accordance with at least one embodiment.

Service server 400 may be a service server or a computing system of a service provider of the payment-by-proxy service. Particularly, service server 400 may perform operations for enabling a cardholder to pay a desired payment for others in connection with user devices of the cardholder and the others and POS terminal 300. In particular, payment service server 400 may provide a predetermined service application for the payment-by-proxy service to user device 200 for creating computing environments and user interfaces for the payment-by-proxy service. Through such computing environments and user interfaces, user device 200 may be enabled to interact with service server 400 for the payment-by-proxy service.

For example, service server 400 may receive a registration request from user device 200 with information on a primary payment card and joint payment cards and perform the registration operation for registering a cardholder as a service member with information on the primary payment card and the joint payment cards. In addition, service server 400 may receive a payment request from POS terminal 300 with information on a joint payment card used to make the payment request. Service server 400 may determine a primary payment card linked to the joint payment card and provide information on the primary payment card to POS terminal 300 to process the payment request with the information on the primary payment card instead of information on the joint payment card.

In accordance with at least one embodiment, service server 400 may perform i) operation for creating initiation data for indicating and initiating the payment-by-proxy service when a payment card is registered for the payment-by-proxy service and ii) operation for transmitting the created initiation data to at least one of user devices of associated cardholders and a financial institution server associated with the payment card. Such service server 400 will be described in detail with reference to FIG. 2.

FIG. 2 illustrates a service server, a POS terminal, and a user device for providing a payment-by-proxy service in accordance with at least one embodiment.

Referring to FIG. 2, such service server 400 may include receiver 410, transmitter 420, processor 430, and memory 430. Although service server 400 is illustrated as including four constituent elements, the embodiments of the present disclosure are not limited thereto.

Receiver 410 receives various types of signals, data, and messages from user device 200, POS terminal 300, and associated financial institution servers through communication network 500. For example, receiver 410 receives a request for applications associated with the payment-by-proxy service, a request for registering a cardholder, a request for registering one of payment cards as a primary payment card and a joint payment card, a request for processing a payment request made using a joint payment card, information on payment cards, the cardholder, and so forth.

Transmitter 420 transmits signals, data, and message to user device 200, POS terminal 300, and associated financial institution servers through communication network 500. For example, transmitter 420 transmits applications associated with a mobile payment service in response to a request from user device 100, a digital version of a mobile payment card in response to the request for the issuance of a mobile payment card, a set of virtual payment card numbers associated with a respective mobile payment card, and a payment approval message as a result of processing a payment request from user device 100.

Memory 430 stores applications necessary for the payment-by-proxy service, information on user device (e.g., user device 200) registered as a member for the payment-by-proxy service, information on payment cards of each registered member, information on primary payment cards and joint payment cards of each registered member, information on a selection policy of each registered member, and information on payment conditions of each registered member. Such information may be stored in a form of a mapping table or a predetermined database for searching and fetching data according to a predetermined keyword.

Processor 440 is a central processing circuitry for performing operations for providing the payment-by-proxy service in accordance with at least one embodiment. For example, processor 440 performs operations of providing a service application for the payment-by-proxy service to user device 200. Processor 440 may generate a signal or a message that initiates at least one of a user device, POS terminal 300, and financial institution server 600 to perform predetermined operations for the payment-by-proxy service. Processor 440 may perform i) operations for registering a cardholder as a service member; ii) operations for setting payment conditions for each payment card or each cardholder; iii) operations for setting a selection policy; iv) operations for identifying a primary payment card linked to a payment card used to make a payment request; v) operations for providing the information on the identified primary payment card to POS terminal 300; and vi) operations for generating and transmitting various types of messages to POS terminal 300 and user device 200.

In accordance with at least one embodiment, POS terminal 300 may i) receive a payment request message from user device 200 upon generation of predetermined events through a communication link (e.g., wireless or wired) established between POS terminal 300 and user device 200. The payment request message may include information on identification of a payment card for requesting a payment, which is referred to as identification data of the payment card. The payment request message may include initiation data for indicating the payment-by-proxy service and initiating operations for the payment-by-proxy service. The initiation data is also referred to as a payment type data field and initiation information throughout the present specification for convenience and ease of understanding. The present embodiment is not limited thereto.

In particular, POS terminal 300 may be any computing device capable of communicating with associated servers (e.g., service server 400 and financial institution server 600), user devices 210 and 220, and a payment card (e.g., contactless, multifunctional, programmable smart card). For example, POS terminal 300 may be a personal computer, a laptop computer, a tablet PC, a pad-like device, a smart phone, and so forth. Furthermore, POS terminal 300 may be a dedicated device for processing a payment card or for reading and writing NFC tag contents. For example, POS terminal 300 may be at least one of a payment terminal, a cash register, a banking machine, as a dedicated device for processing a payment card. POS terminal 300 may be a NFC card reader, or a NFC card scanner as a dedicated device for reading and writing NFC tag contents. In accordance with at least one embodiment, such POS terminal 300 may include sensor 310, communication processor 320, payment card processor 330, NFC tag processor 340, display 350, and main processor 360.

Sensor 310 may be sense a user device or a payment card located within a predetermined distance. Communication processor 320 may communicate with at least one of user devices 210 and 220, service server 400, financial institution server 600, and a payment card based on a predetermined communication protocol and using predetermined radio frequency (RF) bands. For example, communication processor 320 may employ ISO-14443 for communication between POS terminal 300 and a multifunction smart card. Furthermore, a 13.56 MHz band may be used for communication therebetween. Furthermore, communication processor 320 may communicate with related servers through network 500. Furthermore, sensor 310 may scan a mobile payment card, a predetermined code pattern image, and a dummy payment card, which are displayed on a screen of a user device and provide the scanned information to payment card processor 330. In this case, sensor 310 may be an image capturing device, such as a camera. In addition, sensor 310 may read information in a magnetic strip of a payment card and transmit the read information to the payment card processor 330.

Payment card processor 330 may perform operations for processing a payment made through a payment card. For example, payment card processor 330 may be activated when POS terminal 300 operates as a payment processing mode, when a user device having a mobile payment card is sensed within a predetermined distance, and when a contactless smart payment card is sensed. Upon the activation, payment card processor 330 may communicate with at least one of the user device and the smart payment card through communication processor 320 to obtain an identification data and an initiation data from the user device and/or the payment card. In addition, payment card processor 330 may receive the scanned information or the read information from sensor 310.

Payment card processor 330 may determine whether the obtained information, the scanned information, or the read information includes the initiation data or not. Such operation may be performed i) based on a software program downloaded from service server 400 and installed in POS terminal, ii) based on a software module or a hardware module updated by a manufacturer or a service provider, or iii) based on a programmable circuit board included in POS terminal 300, but the present embodiment is not limited thereto. Based on such configuration, POS terminal 300 may be instructed and controlled to detect an initiation data for the payment-by-proxy service in accordance with at least one embodiment.

When the initiation data is not detected, payment card processor 330 may perform a typical payment card process in cooperation with main processor 360. That is, the identification data (e.g., typical payment card information) may be transmitted to financial institution server 600 (e.g., payment gateway or VAN server) and receive a result of processing the payment from financial institution server 600.

When the initiation data is detected, payment card processor 330 indicates that associated payment card is registered for the payment-by-proxy service and performs predetermined operation for initiating the payment-by-proxy service based on information included in the initiation data. For example, payment card processor 330 may perform operations based on the pre-installed software programs or by executing the executable files (e.g., applet) included in the initiation data. Upon the indication, payment card processor 330 may transmit the payment request message to service server 400 based on the information included in the initiation data, instead of transmitting the payment request message to financial institution server 600, in cooperation with main processor 360 and communication processor 320.

NFC tag processor 340 may perform operations for recognizing a smart payment card as a NFC tag, reading associated NFC tag contents, processing the NFC tag contents, and writing new NFC tag contents in the smart card. NFC tag processor 340 may transmit the read contents to payment card processor 330. Display 350 may be an interface between a user and POS terminal 300 to show information to the user. Main processor 360 may perform general operations for controlling POS terminal 300. Main processor 360 may control other constituent elements including sensor 310, communication processor 320, payment card processor 330, NFC tag processor 340, and display 350.

In accordance with at least one embodiment, POS terminal 300 may be installed with a software program and/or a hardware device i) for detecting and recognizing the initiation data included in a payment card or transmitted from user devices 210 and 220, ii) for creating a payment request message to include an identification data of a sensed payment card and transmitting the created payment request message to service server 400, and iii) for using information (e.g., identification data) of a primary payment card linked to the sensed payment card and received from service server 400 to process a payment made by the sensed payment card.

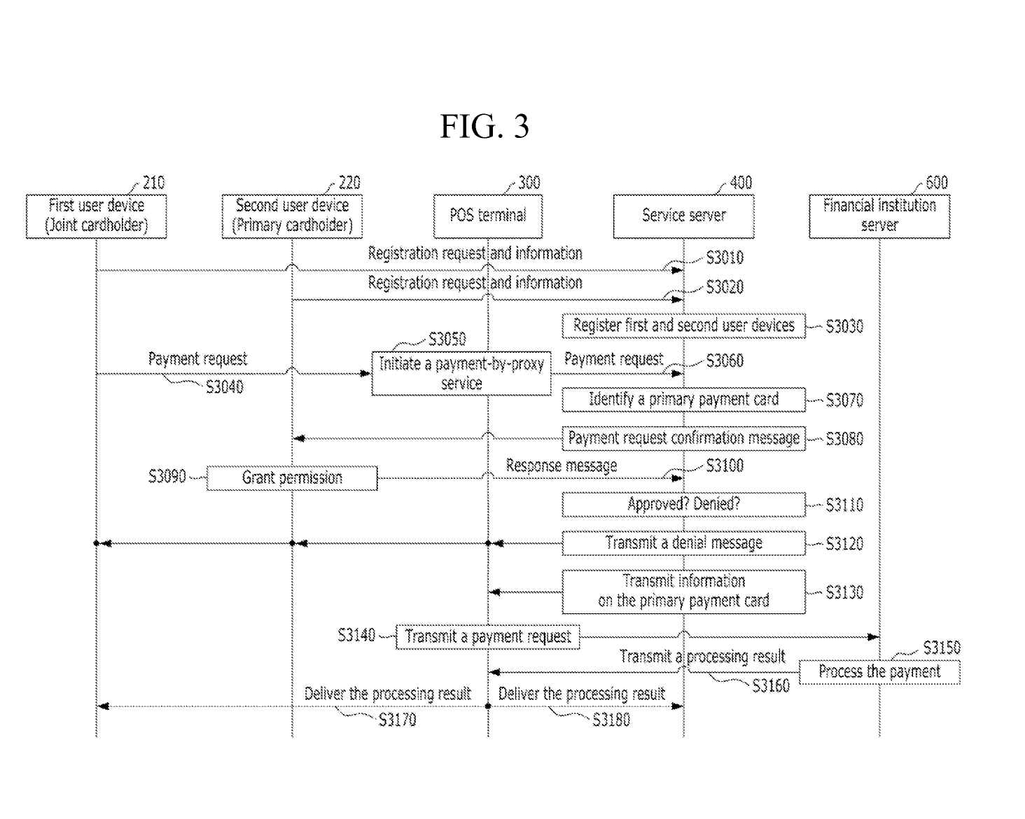

As described, payment card processing system 100 may include service server 400, user device 200, POS terminal 300, and financial institution server 600 as shown in FIG. 1. Hereinafter, overall operation of payment card processing system 100 for providing a payment-by-proxy service will be described with reference to FIG. 3.

FIG. 3 illustrates overall operation of a payment card processing system for a payment-by-proxy service in accordance with at least one embodiment.

Referring to FIG. 3, at step S3010 and S3020, user devices 210 and 220 may transmit a registration request message with registration information to service server 400. Such operation of user devices 210 and 220 may be performed through a graphic user interface produced by executing a service application installed in respective user devices 210 and 220 and displayed on respective screens of user devices 210 and 220. Through the graphic user interface, a first cardholder of first user device 210 may be enabled to register at service server 400 as a service member for the payment-by-proxy service with the registration information on the cardholder, at least one primary payment card, at least one joint payment card, a selection policy, payment conditions, and so forth. Through the graphic user interface, a second cardholder of second user device 220 may be enabled to register at service server 400 as a service member for the payment-by-proxy service with the registration information on the cardholder, at least one primary payment card, at least one joint payment card, a selection policy, payment conditions, and so forth. Through such registration, the first cardholder may register one of payment cards of the second cardholder as a primary payment card for payment cards of the first cardholder. The second cardholder may register payment cards of the first cardholder as joint payment cards.

At step S3030, service server 400 may receive the registration request and the registration information from first and second user devices 210 and 220 and register the first and second cardholders of user devices 210 and 220 as service members for the payment-by-proxy service in connection with the registration information. For example, the first cardholder (e.g., first user device 210) may be registered as a joint cardholder of the second cardholder (e.g., second user device 220), and the second cardholder may be registered as a primary cardholder for the first cardholder.

At step S3040, first user device 210 (e.g., joint cardholder) may transmit a payment request with information on a joint payment card to POS terminal 300. At step S3050, POS terminal 300 may indicate initial data included in the information of the payment request and initiate operation for the payment-by-proxy service. At step S3060, POS terminal 300 may deliver the received payment request with the information on the joint payment card from first user device 210 to service server 400.

At step S3070, service server 400 may i) recognize that the received payment request is made using the joint payment card of first user device 210 (e.g., joint cardholder), ii) identify, as a primary cardholder, the second cardholder (e.g., second user device 220) having a primary payment card linked to the joint payment card, and iii) obtain information on second user device 200, a primary payment card, and associated payment conditions based on the information included in the payment request.

At step S3080, service server 400 may generate and transmit a payment request confirmation message to the identified primary cardholder (e.g., second user device 220). At step S3090, second user device 220 may receive the payment request confirmation message, display information on the payment request made based on the joint payment card (e.g., first user device 210), and receive one of an approval input and a denial input from the primary cardholder.

At step S3100, second user device 200 may generate a response message based on the user input and transmit the generated response message to service server 400. At step S3110, service server 400 may determine whether the response message is the approval message and the denial message. When the response message is the denial message, service server 400 may transmit a denial message to POS terminal 300, first user device 210 and second user device 220 at step S3120.

When the response message is the approval message, service server 400 may transmit the approval message to POS terminal 300 with information on the identified primary payment card at step S3130. At step S3140, POS terminal 300 may generate and transmit a payment request with the information on the primary payment card to associated financial institution server 600. At step S3150, financial institution server 600 may process the payment request with the information on the primary payment card (e.g., second user device 220) although the payment request is actually made based on the joint payment card (e.g., first user device 210).

At step S3160, financial institution server 600 may provide the result of processing to POS terminal 300. At step S3170, POS terminal 300 may deliver the result to first user device 210 that made the payment request (e.g., joint cardholder). POS terminal 300 also deliver the result to service server 400 at step S3180.

As described, with single data transaction to POS terminal 300, a purchaser may be enabled to make a payment for own purchase using a designated persons' payment card without possessing the designated persons' payment card and without complicated authentication process for using the designated persons' payment card. That is, single operation of a user device (e.g., a cardholder) could initiates a payment-by-proxy service that enables a cardholder to pay a predetermined payment for an authorized person using a designated payment card of the cardholder in accordance with at least one embodiment.

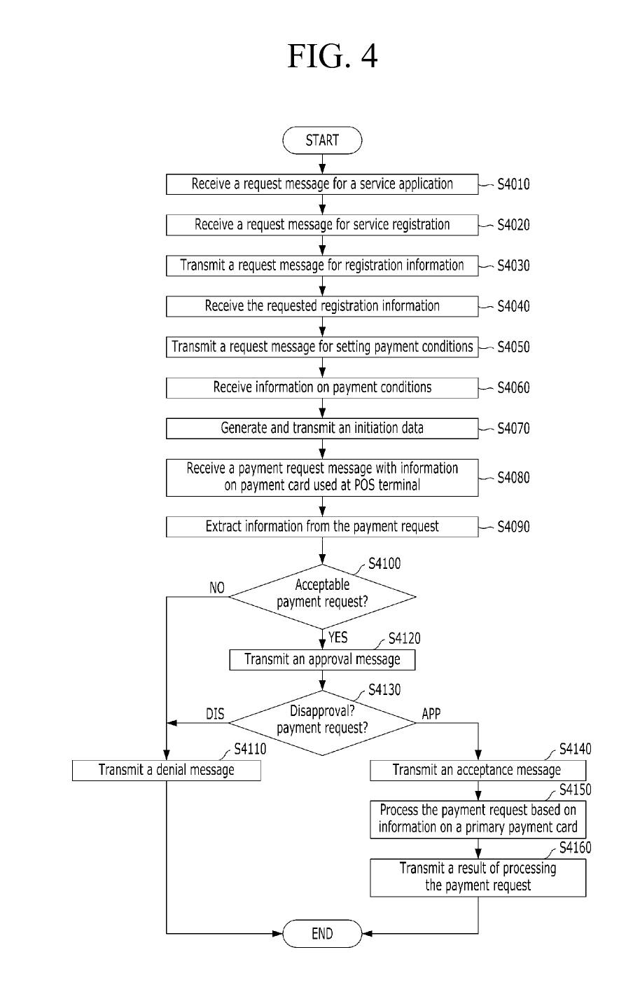

Hereinafter, operation of service server 400 for such a payment-by-proxy service will be described with reference to FIG. 4 to FIG. 8. FIG. 4 is a flowchart illustrating operation of a service server for a payment-by-proxy service in accordance with at least one embodiment. FIG. 5 illustrates payment cards classified into a primary payment card and a joint payment card in accordance with at least one embodiment. FIG. 6 illustrates graphic user interfaces displayed on a user device for registration and creating payment conditions in accordance with at least one embodiment. FIG. 7 illustrates graphic user interfaces displayed on a user device for creating and configuring payment conditions for each joint cardholder in accordance with at least one embodiment, and FIG. 8 illustrates graphic user interfaces displayed on a user device for selecting one from multiple primary payment cards based on a selection condition in accordance with at least one embodiment.

Referring to FIG. 4, a message for requesting a dedicated software program for the payment-by-proxy service may be received from a user device of a cardholder and provided to the user device at step S4010. For example, service server 400 receives a request message for requesting a dedicated software program for the payment-by-proxy service from user device 220 of a cardholder through communication network 500. Such a message may include information on an address (e.g., Internet address, multiple access control (MAC) address), identification, and a system specification of user device 220. Based on the information included in the message, service server 400 is enabled to establish a communication link (e.g., communication session) to exchange data through necessary entities on communication network 500.

Such event may be invoked as follows: i) a cardholder accesses a website, published on the Internet by a service provider of the payment-by-proxy service, using user device 200, ii) the cardholder selects and activates one of menus of the website for downloading the dedicated software program for the payment-by-proxy service, iii) a server (e.g., service server 400) associated with the website fetches the dedicated software program from a database (e.g., memory), and iv) the server transmits the fetched software program to user device 200 through communication network 500. However, the embodiments of the present disclosure are not limited thereto. Such a dedicated software program may be downloaded from a typical software internet market place or application market place (e.g., an App store, a Google market) or a third party website. In addition, the dedicated software program may be obtained from a computer readable recording medium, such as a compact disk (CD) and a digital versatile disc (DVD), distributed by a payment-by-proxy service provider. Such a server associated with the website for the dedicated software program is referred to as service server 400 for convenience and ease of understanding, but the embodiments of the present disclosure are not limited thereto.

User device 200 downloads the dedicated software program and installs the downloaded software program in response to user inputs made through a user interface of user device 200. The dedicated software program may be an application or application software, a mobile app, and/or a web app, which are designed to produce a user interface and a computing environment in a user device (e.g., a computer, a smart phone, a laptop) for the payment-by-proxy service. Hereinafter, the dedicated software program will be referred to as a dedicated service application.

For example, the dedicated service application is executed on user device 220 in response to a predetermined user input of a cardholder or an owner of user device 220. Such execution of the dedicated service application may produce a computing environment and a user interface for the payment-by-proxy service. That is, a computer environment may be created i) for establishing at least one of connections (e.g., session) between service server 400 and user device 200, between user device 200 and POS terminal 300, between user device 200 of a cardholder and a user device of the authorized person, and between user device 200 and an associated financial institution server, ii) for exchanging necessary data and messages through the established connections, and iii) for creating and displaying at least one user interface for enabling a cardholder to pay a desired payment for an authorized person. In addition, a computer environment may be created iv) for designating a predetermined section of a memory and storing initiation data, v) for transmitting the stored initiation data to a designated destination upon generation of a predetermined event, vi) for modifying a mobile payment card, stored and installed in the user device, to include the initiation data, and so forth. The user interface may be created to enable a user 1) for interacting with service server 400, 2) for interacting with associated financial institution servers, 3) for interacting with a user device of a joint cardholder, 4) for registering as a member for the payment-by-proxy service, 5) for registering information on at least one of payment cards, 6) for setting and registering payment-by-proxy policies (e.g., payment conditions) of each payment card, 7) for exchanging messages (e.g., approval messages) with service server 400, associated financial institution servers, and user devices of joint cardholders, 8) for making a payment of a predetermined purchase, and so forth. However, the embodiments of the preset disclosure are not limited thereto.

Such a user interface may be a set of hardware buttons, knots, and keys of a user device, which are adequately modified, configured, and set for the payment-by-proxy service in connection with services server 400. In addition, the user interface may be a set of graphical buttons, icons, a list of menus, knots, and keys, which are displayed on a touch screen of a user device. In particular, the user interface may be a graphic user interface (GUI) that is displayed on a touch screen of a user device and includes various types of graphical buttons, icons, and knots for selecting, activating, setting, modifying, and controlling various operations, options, and conditions for the payment-by-proxy service. Examples of such a user interface are shown in FIG. 6 to FIG. 8. The detailed descriptions of the computing environment and the user interface for the payment-by-proxy service will follow with reference to FIG. 6 to FIG. 8.

In accordance with at least one embodiment, payment cards for the payment-by-proxy service may include i) a plastic payment card (e.g., 5400 in FIG. 5) having a magnetic strip storing the identification data and the initiation data, ii) a multifunctional smart card (e.g., 5500 in FIG. 5) having a memory for storing the identification data and the initiation data and a processor for performing operations based on the initiation data, iii) a mobile payment card (e.g., 5310) issued by an associated financial institution, transmitted to, installed, and stored in the user device, modified to transmit the initiation data stored in a predetermined memory sector of the user device when a designated device (e.g., POS terminal 300) requests the identification data of the mobile payment card, iv) a predetermined code pattern image (e.g., QR code image 5320) created by service server 400 to include coding images of an identification data of a payment card and an initiation data, transmitted to, installed by, and stored in a user device, and displayed on a screen of the user device when it needs, and vi) a dummy mobile card (e.g., dummy mobile card 5330) created by service server 400 with an identification data of a payment card and an initiation data, transmitted to, installed by, and stored in a user device, displayed on a screen of the user device when it needs, and transmitted to a designated device when the identification data is requested.

At step S4020, a service registration request message may be received. For example, service server 400 receives, from user device 220 of a cardholder, a service registration request message for registering a cardholder as a service member for the payment-by-proxy service through communication network 500. Such a service registration request message is generated in response to a user input made by a cardholder through a graphic user interface produced by execution of the dedicated service application and displayed on a screen of user device 200.

As shown in a diagram (A) of FIG. 6, graphic user interface 6100 may provide menu 6101 for registering for the payment-by-proxy service, menu 6102 for setting a selection policy for selecting one of primary payment cards, and menu 6130 for setting payment conditions. For example, when a cardholder clicks menu 6001, a service registration procedure is initiated. Upon the initiation of the service registration procedure, user device 200 establishes communication connection to service server 400 and exchange messages and data through the established communication connection for registering the cardholder of user device 200 as a service member for the payment-by-proxy service at service server 400.

Referring back to FIG. 4, at step S4030, an information request message may be transmitted. For example, in response to the service registration request message, service server 400 generates and transmits an information request message for requesting registration information necessary for service registration. Such requested registration information may include i) information on identification of a cardholder of user device 220, ii) information on at least one of payment cards, as primary payment cards, iii) information on identification on at least one of joint cardholders, and iv) information on at least one of payment cards, as joint payment cards, of joint cardholders, but the embodiments of the present disclosure are not limited thereto. Furthermore, information on user device 200, such as operating system, hardware specification, identification, may be automatically obtained from user device 200. The identification information of a cardholder of user device 220 may include information on a name, an address, a password, an account number associated with each payment card to be registered, and so forth.

Such an information request message of service server 400 may invoke the service application installed and executed in user device 200 to produce and display graphic user interface 6200 for requesting the cardholder of user device 220 to enter the necessary information through graphic user interface 6200, as shown in a diagram (B) of FIG. 6. Such graphic user interface 6200 includes input boxes 6201 to 6204 to enable the cardholder to enter the requested registration information. The embodiments of the present disclosure are not limited thereto. For example, without the information request message, the service application executed in user device 200 may automatically produce and display a graphic user interface for requesting the necessary information to a cardholder of user device 200, similar to graphic user interface 6200.

Referring back to FIG. 4, at step S4040, the registration information for the service registration may be received and stored. For example, in response to the information request message, user device 200 requests the registration information to the cardholder and obtains the requested registration information form the cardholder as shown in the diagram (B) of FIG. 6. User device 220 generates predetermined data packets including the entered registration information and transmits the generated packet packets having the registration information of the cardholder to service server 400 through communication network 500.

Service server 400 stores the received registration information in connection with the identification information of the cardholder in memory 430. For example, service server 400 may generate and manage a database for storing information on a plurality of cardholders registered for the payment-by-proxy service. Each cardholder may be virtually mapped to associated registration information in the database.

At step S4050, a payment condition request message may be transmitted. For example, service server 400 transmits a payment condition request message to user device 200 through communication network 500. Through the payment condition request message, service server 400 requests a primary card holder for creating or setting a set of payment conditions for each joint cardholder. As described, a payment condition denotes conditions set by a primary cardholder for accepting (e.g., allowing) a payment request from a joint cardholder. For example, a payment condition may include i) a condition for designating one primary payment card or multiple primary payment cards for a joint cardholder, ii) a condition for selecting one from the multiple primary payment cards for a joint cardholder, iii) a maximum payment amount allowed to each joint cardholder, iv) types of merchants permitted to each joint cardholder, v) an approval type (e.g., an auto approval and a real-time approval), vi) payment request limitation (e.g., single time, ten times, or no-limit, vii) identification types of each joint cardholder (e.g., a name of a joint cardholder, a telephone number of a user device of a joint cardholder, an identification number issued by service server 400 to a joint cardholder, a password registered by a joint cardholder, and a predetermined code pattern generated by service server 400 and issued to a user device of a joint cardholder). The embodiments of the present disclosure are not limited thereto.

Such a payment condition request message of service server 400 may invoke the service application installed and executed in user device 220 to produce and display various graphic user interfaces 7100 to 7300 and 8100 and 8200 for requesting the cardholder of user device 220 to create and/or to set payment conditions of each joint cardholder, as shown in FIG. 7 and FIG. 8.

FIG. 7 illustrates graphic user interfaces for setting payment conditions for each joint cardholder in accordance with at least one embodiment. Referring to FIG. 7, a primary cardholder, for example, John, is enabled to set conditions for accepting a payment request from associated joint cardholders, for example, Kelly, Jason, and Joshua. A diagram (A) of FIG. 7 shows graphic user interface 7100 for selecting one of Kelly's joint payment cards and setting payment conditions of the selected payment card. When menu 6103 in graphic user interface 6100 in FIG. 6 is selected, one of graphic user interfaces 7100, 7200, and 7300 for setting payment conditions may be produced and displayed as shown in diagrams (A), (B), and (C) of FIG. 7. For example, setting payment conditions may be performed as follows: i) a target card (e.g., visa card) is selected from Kelly's joint payment cards, as shown in selection scroll box 7110; ii) an image of selected visa card 5210 may be displayed as shown in FIG. 7; iii) a maximum payment amount (e.g., a payment condition) for the selected visa card is set as 5,000.00 dollar at box 7120; and iv) permitted merchant types are set using selection buttons 7130, as shown in FIG. 7. John may set payment conditions for payment cards of Jason and Joshua, as shown in graphic user interfaces of 7200 and 7300 in diagrams (B) and (C) of FIG. 7.

FIG. 8 illustrates graphic user interfaces for setting a selection policy for each joint cardholder in accordance with at least one embodiment. As shown in FIG. 8, one of multiple primary payment cards may be selected based on a selection policy set by a primary cardholder in accordance with at least one embodiment. For example, diagrams (A) and (B) of FIG. 8 illustrate setting a selection policy by a merchant type. When menu 6102 in graphic user interface 6100 in FIG. 6 is selected, one of graphic user interfaces 8100 and 8200 for setting a selection policy may be produced and displayed as shown in diagrams (A) and (B) of FIG. 8. Referring to the diagram (A) of FIG. 8, when a merchant type is selected as Restaurant in selection box 8110, a list of candidate primary payment cards 8120 may be automatically selected and displayed. Such a list may be generated based on information on a selected merchant type and information on each payment card, such as benefits obtained by use at the selected merchant type, but the present embodiment is not limited thereto. One of the candidate cards may be selected by clicking one of names in 8120. The selected candidate card may be registered as a primary payment card to be used when associated joint payment cards are used to make a payment request at restaurants (e.g., selected merchant type).

Referring to the diagram (B) of FIG. 8, when a merchant type is selected as Book store (e.g., education) in selection box 8210, a list of candidate primary payment cards 8220 may be automatically selected and displayed. Such a list may be generated based on information on a selected merchant type and information on each payment card, such as benefits obtained by use at the selected merchant type, but the present embodiment is not limited thereto. One of the candidate cards may be selected by clicking one of names in 8220. The selected candidate card may be registered as a primary payment card to be used when associated joint payment cards are used to make a payment request at bookstores (e.g., selected merchant type).

Referring back to FIG. 4, user device 200 may receive user inputs for setting payment conditions and a selection policy as described above, generate data packets to include information on the payment conditions and the selection policy, and transmit the generated data packets to service server 400. That is, at step S4060, information on payment conditions may be received. For example, service server 400 receives information on payment conditions and selection policies from user device 200 and store the received information in the database in connection with each cardholder.

At S4070, initiation data may be generated and transmitted to associated user devices. After the registration, service server 400 may generate initiation data for indicating and initiation the payment-by-proxy service and provide the generated initiation data to at least one of associated user devices 210 and 220 and associated financial institution server 600 after the registration operation S4050.

As described with reference to FIG. 1, the initiation data may include i) initiation-bits (e.g., a payment type data field) for indicating that an associated payment card is registered for the payment-by-proxy service, ii) information on service server 400 (e.g., internet address) for enabling a designated device (e.g., POS terminal 300) to transmit a payment request received from a payment card or from a user device to service server 400, and iii) a set of executable files (e.g., applets) for controlling a designated device (e.g., POS terminal 300, user device 200) to initiate and perform predetermined operations for the payment-by-proxy service. Furthermore, the initiation data may include information on an associated primary cardholder, associated payment conditions, and a selection policy. The initiation data may be i) transmitted to and stored in a user device in connection with an associated mobile payment card, ii) transmitted to and stored in an IC chip of an associated payment card, iii) stored in a magnetic strip of an associated payment card, and iv) transmitted to and stored in a memory of associated financial institution server, but the present embodiment is not limited thereto. Such initiation data may initiate operations for the payment-by-proxy server upon the detection and prior to processing a payment request In accordance with at least one embodiment. The institution data may be created with a dummy mobile payment card or a predetermined code pattern image and transmitted to a user device.

At step S4080, a payment request message may be received from a point-of-sale (POS) terminal of a merchant. For example, service server 400 receives a payment request message from POS terminal 300 of a predetermined merchant when a cardholder, registered for the payment-by-proxy service, uses a payment card for making a payment to the merchant for buying a product or a service from the merchant. In particular, when such a registered cardholder wants to make a payment using a payment-by-proxy service, when a joint cardholder asks a primary cardholder to pay for predetermined purchases made by the joint cardholder, or when a joint cardholder wants to use a primary payment card associated with the joint cardholder to pay for purchases of the joint cardholder, the registered cardholder may provide a joint payment card registered for the payment-by-proxy service to a POS terminal of a merchant. In accordance with at least one embodiment, the joint payment card registered for the payment-by-proxy service may include one of i) a plastic payment card containing information on the payment-by-proxy service, ii) a virtual payment card displayed on a screen of user device 210 of the joint cardholder, iii) a predetermined code pattern generated by service server 400, transmitted to user device 210, and displayed on a screen of user device 210, iv) a digital signal transmitted from user device 210 to POS terminal 300 of a merchant, v) an identification of the joint card holder, and vi) an identification of user device 210 of the joint card holder. The embodiments of the present disclosure are not limited thereto. For example, a joint payment card may be any forms of indication that invokes a terminal (e.g., POS terminal) of a merchant to generate predetermined messages including information on a joint cardholder, a purchase, and a merchant, to transmit the generated message to service server 400, and to process a payment made by the joint cardholder using information on a payment card provided from service server 400. That is, in response to the message to service server 400, the POS terminal may receive information on a primary payment card linked to the joint payment card from service server 400 and perform operations for processing the payment based on the received information on the primary payment card in accordance with at least one embodiment.

Such a joint payment card may include, as the initiation data, a data field having a predetermined value indicating a request of the payment-by-proxy service. Such a data field may be defined by agreements among service providers of the payment-by-proxy service, financial service providers (e.g., e-commerce service providers), credit card service providers, and so forth. For example, a payment type field may be defined to be included in a data structure of a typical credit card. Such a payment type field may have one-bit data. When the payment type field has a value of “1”, the payment type field indicates that an associated cardholder is registered for the payment-by-proxy service and request making a payment through the payment-by-proxy service. When the payment type field has a value of “0”, when the payment type field has no value, or when the payment type field is not included, it might indicate that an associated cardholder is not registered for the payment-by-proxy service.

When the joint cardholder makes a payment at POS terminal 300 using the joint payment card (e.g., one of the above), POS terminal 300 may extract information (e.g., payment type field) from the joint payment card and determine whether the payment-by-proxy service is associated with the payment request made through the joint payment card. Such a payment processing type may be a binary value indicating whether a payment-by-proxy service is associated with the joint payment card or not.

When POS terminal 300 determines that the associated payment card is registered for the payment-by-proxy service, POS terminal 300 may generate a payment request message and transmit the generated payment request message to service server 400. Such a payment request message may include at least one of information on the joint payment card, information on the purchase, information on the merchant, information on time of the purchase, information on the joint cardholder, and information on user device 200 of the joint cardholder. POS terminal 300 transmits the generated payment request message to service server 400 through communication network 500.

POS terminal 300 was described as detecting the initiation data (e.g., payment type data field) stored in the joint payment card. However, the present embodiment is not limited thereto. For example, POS terminal 300 may deliver all of payment requests with information used payment cards to service server 400. In this case, service server 400 may determine whether the initiation data is included or not. For another example, POS terminal 300 may process a payment request through a typical method. That is, POS terminal 300 may request an associated financial institution server to process the payment request. In this case, the initiation data of the payment card may be transmitted to the associated financial institution server, and the financial institution server may perform operations for the payment-by-proxy service.

At step S4090, information on the payment-by-proxy service may be extracted from the received payment request message. For example, service server 400 extract information from the received payment request message and analyze the extracted information to determine a primary cardholder for paying the purchase. In detail, service server 400 may extract information on a cardholder and information on a purchase (e.g., payment) from the payment request message. For example, the extracted information may include i) information on identification of a payment card (e.g., a type of a payment card, a payment card number, an associated account number, an expiration date, a security number, and so forth), ii) information on identification of a cardholder, iii) information on identification of user device 210 of the joint cardholder, iv) information on identification of the merchant, v) information on a purchase, vi) time of purchase, vii) amount of a purchase, and so forth. Based on the extracted information, service server 400 identifies a joint cardholder who made the payment at POS terminal 300, determines a primary cardholder linked to the identified joint cardholder, and fetches information on the primary cardholder, a primary payment card, and associated payment conditions, which are linked to the identified joint payment card used to make the payment at POS terminal 300. As described, each registered cardholder may provide information on at least one primary payment card, at least one joint payment card, payment conditions for each payment card, payment request confirmation methods, and so forth, during the registration procedure. Such information may be stored in the database of service server 400 in connection with identification of each payment card, each cardholder, and/or each user device, registered for the payment-by-proxy service in accordance with at least one embodiment. Accordingly, service server 400 performs at least one of operations for i) determining whether a payment card associated with the requested payment is a primary payment card or a joint payment card, ii) fetching information on a primary payment card associated with a joint payment card used for making the payment request, iii) selecting one of multiple primary payment cards associated with a joint payment card used for making the payment request based on a predetermined selection policy, iv) fetching information on a set of payment conditions associated with a primary payment card linked to a joint payment card used for making the payment request, and so forth.

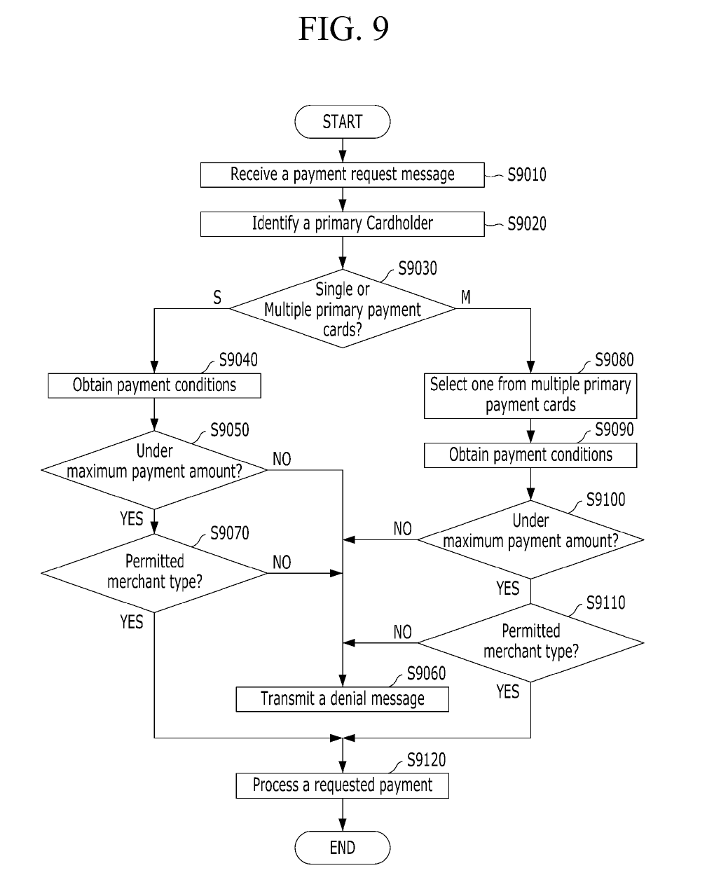

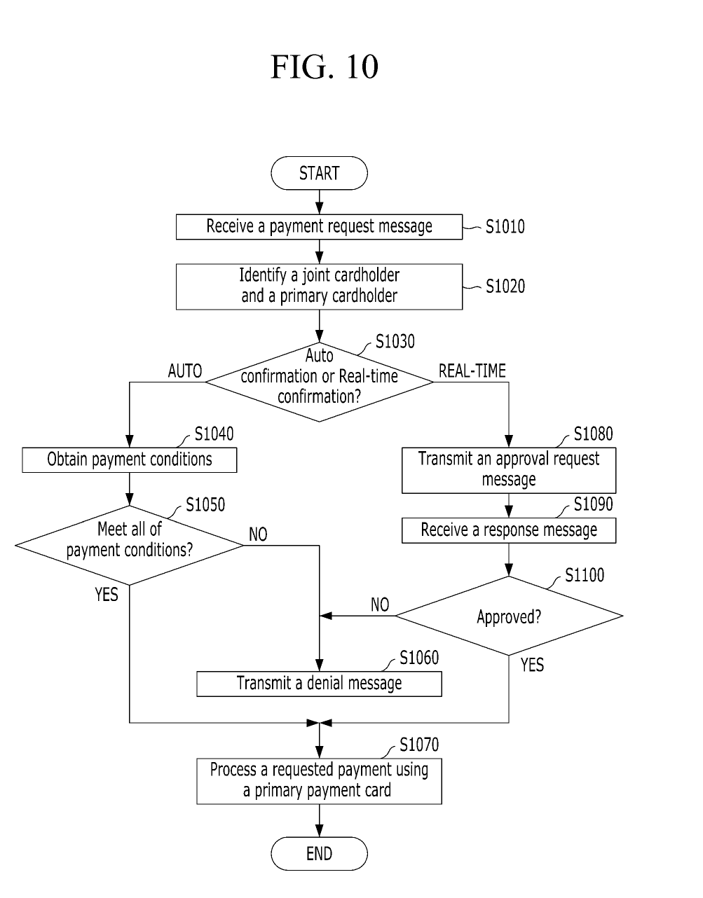

At step S4100, determination may be made whether the payment request is acceptable by the primary cardholder based on the extracted information and the associated payment conditions. For example, service server 400 may determine whether the payment request is acceptable based on the fetched information on the set of payment conditions configured according to a joint cardholder who made the payment request and the information on the purchase, extracted from the payment request message. In detail, service server 400 i) determines whether a payment amount in the payment request is less than a maximum payment amount, ii) determines whether a merchant of the payment request is a permitted merchant, iii) determine whether a purchase time is in a permitted time, iv) determine whether a purchase type is permitted, and so forth based on the fetched information on the set of payment conditions. Such determination may be performed in various ways. The determination operation will be described in detail with reference to FIG. 9 and FIG. 10.

When the payment request is not acceptable (No-S4100), a denial message may be transmitted at step S4110. For example, when the payment request does not meet at least one of the payment conditions associated with the primary payment card, service server 400 determines that the payment request is not acceptable. In this case, service server 400 generates a denial message including information on a reason of denial and transmits the generated denial message to POS terminal 300 through communication network 500. Such a denial message may be transmitted to user device 200 of the joint cardholder who requests the payment and a user device of the primary cardholder who has the primary payment card linked to the joint payment card used to make the payment request.

When the payment request is acceptable (Yes-S4100), an approval request message may be transmitted to a user device of the primary cardholder at step S4120. For example, when the payment request meets all the payment conditions, service server 400 determines that the payment request is acceptable. In this case, service server 400 generates an approval request message and transmits the generated approval request message to a user device of the primary cardholder through communication network 500. Such an approval request message may include information on the payment request, information on the joint cardholder, and so forth.

The approval request message may invoke the service application installed and executed in user device 220 of the primary card holder to produce and display a graphic user interface for requesting the primary cardholder of user device 200 to confirm whether to allow the payment request from the joint cardholder. Through such a graphic user interface, the primary cardholder may be informed when associated joint cardholders purchase a produce or a service using one of payment cards of the primary cardholder and confirm whether the associated joint cardholders use the payment cards of the primary cardholder based on the payment conditions set for each joint cardholder. In addition, such an approval request message may enable the primary cardholder to control use of the primary payment cards and to protect the primary payment cards from illegal use.

When evaluating information of the approval request message, the primary card holder may approve and disapprove the payment request from the joint cardholder. When the primary cardholder approves the payment request, user device 200 generates and transmits an approval response message to service server 400. When the primary cardholder disapproves the payment request, user device 200 generates and transmits a disapproval response message to service server 400. Such response messages may be transmitted to user device 210 of the joint cardholder and POS terminal 300 of the merchant as well, but the embodiments of the present disclosure are not limited thereto.

At step S4130, a response message may be received in response to the approval request message and determination may be made whether the response message is a disapproval message or an approval message. For example, service server 400 receives one of the approval response message and the disapproval response message from user device 220 of the primary cardholder in response to the approval request message.

When the response message is the disapproval response message (DIS-S4130), a denial message may be transmitted to POS terminal 300 at step S4110. For example, service server 400 generates a denial message including information on a reason of denial and transmits the generated denial message to POS terminal 300 through communication network 500. Such a denial message may be transmitted to user device 210 of the joint cardholder who requests the payment and user device 220 of the primary cardholder who has the primary payment card linked to the joint payment card used to make the payment request.

When the response message is the approval response message (App-S4130), an acceptance message may be generated and transmitted to POS terminal 300 at step S4140. For example, upon the receipt of the approval response message, service server 400 determines that the primary cardholder approves the payment request from the joint cardholder, generates the acceptance message, and transmits the generated acceptance message to POS terminal 300 through communication network 500. Such an acceptance message may be transmitted to user device 210 of the joint cardholder who requests the payment and user device 220 of the primary cardholder who has the primary payment card linked to the joint payment card used to make the payment request.

The payment-by-proxy service was described as requesting a primary cardholder to approve a payment request from a joint cardholder. However, the embodiments of the present disclosure are not limited thereto. For example, such an operation (e.g., steps S4120 and S4130) for approving a payment request by a primary cardholder may be omitted. Without the approving operation, the requested payment is processed based on the primary payment card as soon as the requested payment is accepted based on the payment conditions in accordance with another embodiment.

At step S4150, the requested payment may be processed based on the primary payment card. For example, service server 400 may perform operations for paying the purchase made by the joint cardholder using the primary payment card of the primary cardholder. In particular, service server 400 may access a financial institution server of the primary payment card based on information on the primary payment card and request processing a payment of the purchase based on information on the primary payment card. Such operation of service server 400 may be similar to a typical process of requesting a server of a credit card server (e.g., a payment gateway) to make a payment (e.g., electronic transaction or e-commerce) of any credit card. In this case, the financial institution server may not know such a payment request actually made through the joint payment card, not the primary payment card. Furthermore, the financial institution server does not perform any additional operations or needs to be modified for providing the payment-by-proxy service in accordance with at least one embodiment. Since a joint cardholder is also used a payment card issued by financial institution, additional security procedure may be necessary to identify the joint cardholder at POS terminal 300 of a merchant.

However, the embodiments of the present disclosure are not limited to directly requesting the financial institution server to process the payment request. For example, service server 400 may provide information on the primary payment card to POS terminal 300 of the merchant and POS terminal 300 may request the financial institution server to process the payment based on the provided information on the primary payment card. Such an operation of POS terminal 300 may be a typical process of processing a payment made by a typical credit card.

At step S4160, a result of processing the request payment may be transmitted. For example, service server 400 may receive the result of processing the payment request from the financial institution server of the primary payment card and transmit the received result to POS terminal 300 of the merchant. In addition, such a result may be transmitted not only to user device 210 of the joint cardholder but also user device 220 of the primary cardholder.

As described, a cardholder may be enabled to legally and conveniently pay a payment for any desired persons without complicating authorization processes and without modifying a typical e-commerce process in accordance with at least one embodiment. A cardholder may be enabled to conveniently designate and control joint cardholders without interacting with related financial institution servers of associated payment cards and without complicated security processes for authenticating the joint cardholders. In addition, a cardholder may be enabled to legally allow others to use the cardholder's payment cards to others. The maximum benefits of using a desired payment card can be obtained through allowing authorized persons to use the desired payment card through the payment-by-proxy service in accordance with at least one embodiment.

Hereinafter, various embodiments of the payment-by-proxy service will be described with reference to FIG. 9 to FIG. 10. FIG. 9 is a flowchart illustrating operation for a payment-by-proxy service in accordance with one embodiment.

Referring to FIG. 9, service server receives a payment request message from POS terminal 300 at step S9010. For example, service server 400 receives a payment request message from POS terminal 300 when a joint cardholder provides a joint payment card at POS terminal 300. In particular, POS terminal 300 scans information on a payment card and detects a payment type field indicating the payment-by-proxy service in the scanned information. Upon the detection, POS terminal 300 generates the payment request message and transmits the payment request message to service server 400

At step S9020, service server 400 analyzes the payment request message and identifies an associated primary cardholder based on the analysis result. For example, when the service server 400 receives the payment request message from POS terminal 300, the service server 400 extracts information on the joint payment card from the payment request message, identifies a primary cardholder and a primary payment card, which are linked to the joint payment card based on the extracted information, and obtains information on the identified primary payment card from the database. Such obtained information may include information on the identified primary cardholder, the primary payment cards belonging to the identified primary cardholder, joint payment cards associated with the identified primary cardholder, and payment conditions set by the identified primary cardholder for each joint payment card.

At step S9030, service server 400 determines whether the joint payment card is linked to single primary payment card or multiple primary payment cards. That is, service server 400 determines whether the identified primary cardholder designates single primary payment card or multiple primary payment cards to the joint payment card used to make the payment request at POS terminal 300 based on the obtained information.

When the single payment card is linked (S-S9030), service server 400 obtains payment conditions associated with the single payment card at step S9040. For example, service server 400 obtains a maximum payment amount and a permitted merchant type in accordance with the single payment card and the joint payment card, from the database, as the payment conditions.

At step S9050, service server 400 compares the maximum payment amount with a payment amount of the payment request. When the maximum payment amount is not equal to or is not greater than the payment amount (No-S9050), service server 400 transmits a denial message to POS terminal 300 through communication network 500 at step S9060. In addition, service server 400 may transmit the same denial message to user device 210 of the joint cardholder and user device 220 of the primary cardholder.

When the maximum payment amount is equal to or greater than the payment amount (Yes-S9050), service server 400 compares the permitted merchant type with a merchant type of the payment request at step S9070.

When the permitted merchant type is not matched with the merchant type of the payment request (No-S9070), service server 400 transmits a denial message to POS terminal 300 through communication network 500 at step S9060. In addition, service server 400 may transmit the same denial message to user device 210 of the joint cardholder and user device 220 of the primary cardholder.

When the permitted merchant type is matched with the merchant type of the payment request (Yes-S9070), service server 400 processes the payment based on the primary payment card linked to the joint payment card at step S9120.

When the multiple payment cards are linked (M-S9030), service server 400 selects one of the multiple payment cards as a primary payment card based on a selection policy set according to the joint payment card used to make the payment request at POS terminal 300 at step S9080. Such a selection policy may be set by a primary cardholder according to each joint cardholder or each joint payment card during the registration procedure. For example, the selection policy may be set i) to select one providing maximum benefits of use from the multiple primary payment cards, ii) to select one having a highest credit limit from the multiple primary payment cards, iii) to select one having a lowest remaining balance from the multiple primary payment cards, iv) to select one providing a preferred benefit of use from the multiple primary payment cards, and so forth. Service server 400 selects one from the multiple primary payment cards based on the information included in the payment request message and the obtained selection policy.

Service server 400 obtains payment conditions associated with the selected payment card at step S9090. For example, service server 400 obtains a maximum payment amount and a permitted merchant type in accordance with the selected payment card and the joint payment card, from the database, as the payment conditions, but the embodiments of the present disclosure are not limited thereto. Such payment conditions are changed according to various factors, such as a joint payment card, a primary payment card, a payment amount, a merchant type, and so forth.

At step S9100, service server 400 compares the maximum payment amount with a payment amount of the payment request. When the maximum payment amount is not equal to or is not greater than the payment amount (No-S9100), service server 400 transmits a denial message to POS terminal 300 through communication network 500 at step S9060. In addition, service server 400 may transmit the same denial message to user device 210 of the joint cardholder and user device 220 of the primary cardholder.

When the maximum payment amount is equal to or greater than the payment amount (Yes-S9100), service server 400 compares the permitted merchant type with a merchant type of the payment request at step S9110.

When the permitted merchant type is not matched with the merchant type of the payment request (No-S9110), service server 400 transmits a denial message to POS terminal 300 through communication network 500 at step S9060. In addition, service server 400 may transmit the same denial message to user device 210 of the joint cardholder and user device 220 of the primary cardholder.

When the permitted merchant type is matched with the merchant type of the payment request (Yes-S9110), service server 400 processes the payment based on the primary payment card linked to the joint payment card at step S9120. For processing, service server 400 may transmit a request message to associated financial institution server for requesting processing the payment made through the joint payment card by using the primary payment card. Alternatively, service server 400 may transmit a request message or an approval message to POS terminal 300 to process the payment made through the input payment card by using the primary payment card. In this case, POS terminal 300 processes the payment in connection with the associated financial institution server, which is very similar to a process of processing a payment made using a typical credit card.

FIG. 10 is flowchart illustrating operation for a payment-by-proxy service in accordance with another embodiment.

Referring to FIG. 10, service server receives a payment request message from POS terminal 300 at step S1010. At step S1020, service server 400 analyzes the payment request message and identifies a joint cardholder and an associated primary cardholder based on the analysis result.

At step S1030, service server 400 obtains information on a payment request confirmation method linked to the identified primary cardholder and the identified joint cardholder and determines whether the payment request confirmation method is a real-time confirmation method or an auto confirmation method. As described, such the payment request confirmation method may be set according to a joint cardholder and a primary cardholder and stored in the database during the registration for the payment-by-proxy service. The real-time confirmation method requires service server 400 to grant permission for each payment request from a primary cardholder before processing the payment request. The auto confirmation method requires service server 400 to process the payment request without granting permission from a primary cardholder if the payment request meet all of associated payment conditions.

When the auto confirmation method is linked (Auto-S1030), service server 400 obtains payment conditions associated with the identified primary payment card at step S1040. At step S1050, service server 400 compares the obtained payment conditions and information on the payment request.

When at least one of the payment conditions is not met (No-S1050), service server 400 transmits a denial message to POS terminal 300 through communication network 500 at step S1060. In addition, service server 400 may transmit the same denial message to user device 210 of the joint cardholder and user device 220 of the primary cardholder.

When all of the payment condition are met (Yes-S1050), service server 400 processes the payment based on the primary payment card linked to the joint payment card at step S1070. For processing, service server 400 may transmit a request message to associated financial institution server for requesting processing the payment made through the joint payment card by using the primary payment card. Alternatively, service server 400 may transmit a request message or an approval message to POS terminal 300 to process the payment made through the input payment card by using the primary payment card. In this case, POS terminal 300 processes the payment in connection with the associated financial institution server, which is very similar to a process of processing a payment made using a typical credit card.

When the real-time confirmation method is linked (Auto-S1030), service server 400 generates and transmits an approval request message to user device 220 of the primary cardholder at step S1080. Such an approval request message may include information on the payment request from POS terminal 300, information on the primary cardholder and the primary payment card, and information on the joint cardholder and the joint payment cards.

User device 220 receives the approval request message. Such an approval request message may invoke user device 220 to produce and to display a graphic user interface for displaying the information on the payment request made by the joint cardholder using the joint payment card and for receiving a user input to approve the payment request or to deny the payment request. Through such a graphic user interface, user device 220 receives the user input to approve the payment request and to deny the payment request. User device 200 generates a response message based on the user input and transmits the response message to service server 400 through communication network 500.

Service server 400 receives the response message from user device 220 of the primary cardholder in response to the approval request message at step S1090 and determines whether the response message is an approval message or a deny message at step S1100. When the response message is the deny message (No-S1100), service server 400 transmits a denial message to POS terminal 300 through communication network 500 at step S1060. In addition, service server 400 may transmit the same denial message to user device 210 of the joint cardholder and user device 220 of the primary cardholder.

When the response message is the approval message (Yes-S1100), service server 400 processes the payment based on the primary payment card linked to the joint payment card at step S1070. For processing, service server 400 may transmit a request message to associated financial institution server for requesting processing the payment made through the joint payment card by using the primary payment card. Alternatively, service server 400 may transmit a request message or an approval message to POS terminal 300 to process the payment made through the input payment card by using the primary payment card. In this case, POS terminal 300 processes the payment in connection with the associated financial institution server, which is very similar to a process of processing a payment made using a typical credit card.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A payment card for a payment-by-proxy service that receives a payment request made by the payment card and processes the payment request by a primary payment card linked to the payment card, through a payment card processing system including a payment terminal of a merchant, a service server of the payment-by-proxy service, financial institution servers associated with the payment card and the primary payment card, and at least one user device of an associated registered cardholder for displaying the payment card and transmitting information on the payment card to a designated device, the payment card configured to:
store an identification data used for requesting a payment and an initiation data used for processing a payment through the payment-by-proxy service;
generate an initiation message based on the stored initiation data upon receipt of a request signal for the identification data from the payment terminal; and
transmit the generated initiation message to the payment card processing system in response to the request for the identification data,
wherein the generated initiation message invokes the payment card processing system to obtain information on the primary payment card linked to the payment card and to use the obtained information on the primary payment card for processing a payment request made at the payment terminal based on the identification data of the payment card.

2. The payment card of claim 1, wherein:
the payment card is configured to transmit the generated initiation message to the payment terminal when the payment card transmits a signal containing the identification data to the payment terminal in response to the request signal transmitted from the payment terminal; and
upon the receipt of the generated initiation message, the payment terminal generates a payment request message to include information on the payment request based on the identification data, transmits the payment request message to the service server, receives a message containing information on the primary payment card registered to be linked to the payment card from the service server, and process the payment request using the received information on the primary payment card instead of the identification information on the payment card.

3. The payment card of claim 1, wherein:
the payment card is configured to transmit the generated initiation message to the payment terminal when the payment card transmits a signal containing the identification data to the payment terminal in response to the request signal transmitted from the payment terminal; and
the payment terminal transmits a payment request message made based on the identification data of the payment card to the service server instead of a financial institution server of the payment card.

4. The payment card of claim 1, wherein the payment card includes a plastic payment card including an integrated chip storing the initiation data and the identification data, a plastic payment card including a magnetic strip containing the initiation data and the identification data, a mobile payment card which is installed in, displayed on a user device, coupled to a predetermined memory sector for storing the initiation data generated by the service server, a digital form of the payment card generated by the service server to include the initiation data and transmitted to the user device, and a predetermined code pattern image generated by the service server to represent the initiation data and the identification data and transmitted to and displayed on the user device.

5. An apparatus for providing a payment-by-proxy service that receives a payment request made by a joint payment card and processes the payment request by a primary payment card linked to the joint payment card through a payment card processing system including user devices associated with the joint payment card and the primary payment card, a payment terminal of a merchant, financial institution servers associated with the joint payment card and the primary payment card, and at least one user device for displaying the joint payment card and transmitting information on the joint payment card to a designated device, the apparatus comprising:
a communication circuit configured to transmit data, signals, and messages to and to receive data, signals, and messages from at least one of the user devices, the payment terminal, and the associated financial institution servers;
a memory configured to store information on a plurality of cardholders registered for the payment-by-proxy service, identification data of payment cards of each cardholder, and information on primary payment cards and joint payment cards of each cardholder;
a processor configured to generate an initiation data for each registered cardholder upon registration of each cardholder, to identify a first joint payment card based on information included in a payment request message received from and generated by the payment terminal based on identification data of the first joint payment card, to determine a first primary payment card linked to the first joint payment card based on information stored in the memory and the information included in the payment request message, and to transmit information on the determined first primary payment card to the payment terminal
wherein the payment terminal receives the identification data of the first primary payment card from the apparatus and uses the received identification data of the first primary payment card to process the payment request made using the first joint payment card.

6. The apparatus of claim 5, wherein the apparatus is configured to:
receive a request message for a service application from a first user device; and
transmit the requested service application to the first user device,
wherein upon receipt of the service application, the first user device is invoked to install and execute the service application for producing computing environments and user interfaces for interacting with at least one of the apparatus, the payment terminal, and the associated financial institution servers for the payment-by-proxy service.

7. The apparatus of claim 6, wherein the apparatus is configured to:
request and receive registration information of each registered cardholder through the computing environments and the user interfaces, produced by executing the service application in an associated user device and displayed on a touch screen of the associated user device,
wherein the registration information includes information on at least one primary payment card, information on associated joint payment card, information on a primary cardholder, and information on associated joint cardholders.

8. The apparatus of claim 6, wherein the apparatus is configured to:
request setting at least one of payment conditions and a selection policy of each registered cardholder and receive information on the setting result of the payment conditions and the selection policy through the computing environments and the user interfaces, produced by executing the service application in an associated user device and displayed on a touch screen of the associated user device; and
store the received information on the payment conditions and the selection policy of each cardholder.

9. The apparatus of claim 5, wherein:
the apparatus is configured to generate the initiation data based on information on the first joint payment card and to transmit the generated initiation data to the first user device associated with the first joint payment card;
the first user device is configured to receive the initiation data from the apparatus, to store the received initiation data in a memory, and to transmit the initiation data to the payment terminal when the payment terminal requests the identification data of the first joint payment card; and
the payment terminal is configured to transmit a payment request message created based on the identification data of the first joint payment card to the apparatus when the payment terminal receives the initiation data from the first user device in response to the request for the identification of the first joint payment card, to receive the identification data of the first primary payment card from the apparatus in response to the payment request message, and to use the identification data of the first primary payment card for processing the payment request made at the payment terminal using the identification data of the first joint primary payment card.

10. The apparatus of claim 5, wherein:
the apparatus is configured to generate the initiation data based on information on the first joint payment card and to transmit the generated initiation data to the first user device associated with the first joint payment card;
the first user device is configured to receive the initiation data from the apparatus, to configure a mobile payment card of the first joint payment card to include the received initiation data, and to display the mobile payment card on a screen of the first user device in order to transmit the initiation data to the payment terminal when the payment terminal requests the identification data of the first joint payment card; and
the payment terminal is configured to indicate the initiation data in the mobile payment card, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

11. The apparatus of claim 5, wherein:
the apparatus is configured to generate a dummy mobile payment card including the initiation data based on information on the first joint payment card and to transmit the generated dummy mobile payment card to the first user device associated with the first joint payment card;
the first user device is configured to receive the dummy mobile payment card from the apparatus and to display the dummy mobile payment card on a screen of the first user device in order to transmit the initiation data to the payment terminal when the payment terminal requests the identification data of the first joint payment card; and
the payment terminal is configured to indicate the initiation data in the dummy mobile payment card, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

12. The apparatus of claim 5, wherein:
the apparatus is configured to generate a code pattern image including the initiation data based on information on the first joint payment card and to transmit the generated code pattern image to the first user device associated with the first joint payment card;
the first user device is configured to receive the code pattern image from the apparatus and to display the code pattern image on a screen of the first user device in order to transmit the initiation data to the payment terminal when the payment terminal requests the identification data of the first joint payment card; and
the payment terminal is configured to indicate the initiation data in the code pattern image, to transmit a payment request message created based on the identification data of the mobile payment card to the apparatus, to receive the identification data of the first primary payment card from the apparatus in response to the payment request message, and to use the identification data of the first primary payment card for processing the payment request made at the payment terminal using the identification data of the first joint primary payment card.

13. The apparatus of claim 5, wherein the apparatus is configured to:
transmit the identification data of the first primary payment card to the payment terminal when payment conditions of the first primary payment card are satisfied based on information on the payment request made through the first joint payment card.

14. The apparatus of claim 5, wherein the apparatus is configured to:
transmit an approval request message to a second user device associated with the first primary payment card when receiving the payment request message made using the first joint payment card of the first user device; and
transmit the identification data of the first primary payment card to the payment terminal when receiving an approval message from the second user device.

15. The apparatus of claim 5, wherein the apparatus is configured to:
select one obtaining most benefits of use from multiple primary payment cards when multiple primary payment cards are linked to the first joint payment card used to make the payment request message from the payment terminal; and
transmit identification data of the selected primary payment card to the payment terminal.

16. A payment terminal for a payment-by-proxy service that receives a payment request made by a joint payment card and processes the payment request by a primary payment card linked to the joint payment card through a payment card processing system including user devices associated with the joint payment card and the primary payment card, a service server for the payment-by-proxy service, financial institution servers associated with the joint payment card and the primary payment card, and user devices for displaying the payment card and transmitting information on the joint payment card to a designated device, the payment terminal is configured to:
receive a payment request message with identification data of a first joint payment card;
detect an initiation data in the payment request message; and
transmit the payment request message to the service server instead of a financial institution server associated with the identification data of the first joint payment card.

17. The payment terminal of claim 16, wherein the payment terminal is configured to:
receive an identification data of a first primary payment card linked to the first joint payment card from the service server; and
use the received identification data of the first primary payment card to process the payment request made by the identification data of the first joint payment card.

18. The payment terminal of claim 16, wherein the payment terminal is configured to:
receive an identification data of a first primary payment card linked to the first joint payment card from the service server; and
transmit the payment request made by the first joint payment card to a financial institution server associated with the first primary payment card.

19. The payment terminal of claim 16, wherein the payment terminal is configured to:
receive an initiation data with an identification data of a payment card when a payment request is made using the identification data of the payment card; and
initiate a payment-by-proxy service operation upon the receipt of the initiation data.

20. The payment terminal of claim 16, wherein the payment terminal is configured to:
transmit a payment request made based on a first joint payment card to the service server upon detection of an initiation data; and
receive a result of processing the payment request based on a first primary payment card linked to the first joint payment card from a financial institution server associated with the first primary payment without receiving the identification data of the first primary payment from the service server and without transmitting the payment request to the financial institution server associated with the first primary payment card.
